(19) United States
(12) Patent Application Publication
(10) Pub. No.: US 2015/0058466 A1
(43) Pub. Date: Feb. 26, 2015

(54) DEVICE FOR SERVER GROUPING

(71) Applicant: IDEAWARE INC., Seongnam-si (KR)

(72) Inventor: Yang Myung CHA, Yongin-si (KR)

(21) Appl. No.: 14/464,119

(22) Filed: Aug. 20, 2014

(30) Foreign Application Priority Data
Aug. 21, 2013 (KR) 10-2013-0099229
Aug. 27, 2013 (KR) 10-2013-0101475

(51) Int. Cl. H04L 12/24; H04W 8/24; H04L 29/08

(52) U.S. Cl. CPC H04L 41/12; H04L 67/10; H04W 8/24
USPC 709/223

(57) ABSTRACT

Provided is a device and method for server grouping, and the device for server grouping includes a packet collection module for collecting or capturing communication packets for transceiving between at least one wireless terminals and servers, for mapping packet collection or capture time information with server address information, and for including domain names of the servers being transmitted with the packets in the server address information; and a pattern grouping module for identifying address information of the servers connected within predetermined time for each wireless terminal for the mapped packets according to the packet collection or capture time information, connecting the servers connected for each wireless terminal within predetermined time, counting the number of the wireless terminal corresponding to the connection between the servers, and grouping at least one servers connecting the servers having the number of the counted wireless terminal larger than the predetermined number into the group of the servers corresponding to the specific application.

### BACKGROUND OF THE INVENTION

1. Technical Field

The present invention relates to grouping for packet switching servers for each service or application on a wireless network to detect main causes of wireless network loads, that is, services or applications.

2. Description of the Related Art

After supplying smart-phones, patterns using a wireless terminal for individuals are abruptly changed from voice communication to data communication.

In FIG. 1 shown as mobile (wireless) data traffic index, mobile traffics are expected to increase to 26 times in the next 10 to 15 years, and mobile data amount of 15 MB used by individuals per day has been used in 2010 but mobile data amount of 1 GB will be used in 2020.

The increase of the mobile traffics directly effects on profitability and service quality of the mobile-service company and accompanies a service provider, that is, a mobile-service company's equipment expansion, and therefore profit aggravation is inevitable and a user using a mobile network has service dissatisfaction due to data communication velocity delay.

Therefore, the mobile-service company must effectively use network infra to reduce investment burden and to guarantee service quality and an alternative guaranteeing predictability and real-time control is needed due to the limits of current solutions.

For example, as shown in FIG. 2, periodic data polling of various applications installed at the wireless terminals is the main cause of the mobile network jam.

In order to connect one data polling application to the servers, many data communications such as location confirm for base stations are preceded, and the traffics for connecting to application servers are caused even after connecting to the communication network.

Such a data polling execution applications automatically connects to the application servers at a few minute to a few dozen minute intervals and identifies whether data to be updated are present. Since this causes many traffic on the communication network even on no updating data at the application servers and the same processes are periodically repeated, and therefore the overload may be caused on the mobile network.

In order to detect and control the specific services or applications causing overload at the communication network as above, the servers connected with each service or application should be identified on the communication network, wherein there is a problem in that identification information of the wireless terminal and the address information-IP/port information of the servers, etc. only may be identified in the packet information switched on an actual communication network and therefore may not control the services or applications that cause overload.

In order to solve much cost consumption of the mobile communication company due to network jam and service dissatisfaction for users of the wireless terminals, a method for blocking periodic network usage by a plurality of applications disposed at the wireless terminals is absolutely needed, but there is no a solution for this.

### SUMMARY OF THE INVENTION

In order to detect specific services or specific applications that cause overload at a communication network, there is a need for blocking or controlling connection of the specific services or specific applications for a server that cause overload by grouping servers performing packet switching for each specific service or specific application.

Further, the present invention may optimally use the network by server grouping, improve data communication environment of the user and reduce battery consumption by network jam removal while reducing network expansion cost of a mobile communication company and improving service quality by it, and may provide a method and system, and a recording medium for the same capable of using reasonable consultation channels between a application company and the mobile communication company by using the result comparing network usage information.

According to an aspect of the invention, there is provided a device for server grouping including a packet collection module for collecting or capturing communication packets for transceiving between at least one wireless terminals and servers, for mapping packet collection or capture time information with server address information, and for including domain names of the servers being transmitted with the packets in the server address information; and a pattern grouping module for identifying address information of the servers connected within predetermined time for each wireless terminal for the mapped packets according to the packet collection or capture time information, connecting the servers connected for each wireless terminal within predetermined time, counting the number of the wireless terminal corresponding to the connection between the servers, and grouping at least one servers connecting the servers having the number of the counted wireless terminal larger than the predetermined number into the group of the servers corresponding to the specific application.

According to another aspect of the invention, there is provided a method for server grouping including collecting or capturing communication packets for transceiving between at least one wireless terminals and servers, and mapping packet collection or capture time information with server address information including domain names of the servers being transmitted with the packets; and identifying address information of the servers connected within predetermined time for each wireless terminal for the mapped packets according to the packet collection or capture time information, connecting the servers connected for each wireless terminal within the predetermined time, counting the number of the wireless terminals corresponding to the connection between the servers, and grouping at least one servers connecting the servers having the number of the counted wireless terminals larger than the predetermined number into the group of the servers corresponding to the specific application.

### BRIEF DESCRIPTION OF THE DRAWINGS

FIG. 1 shows mobile (wireless) data traffic indexes.

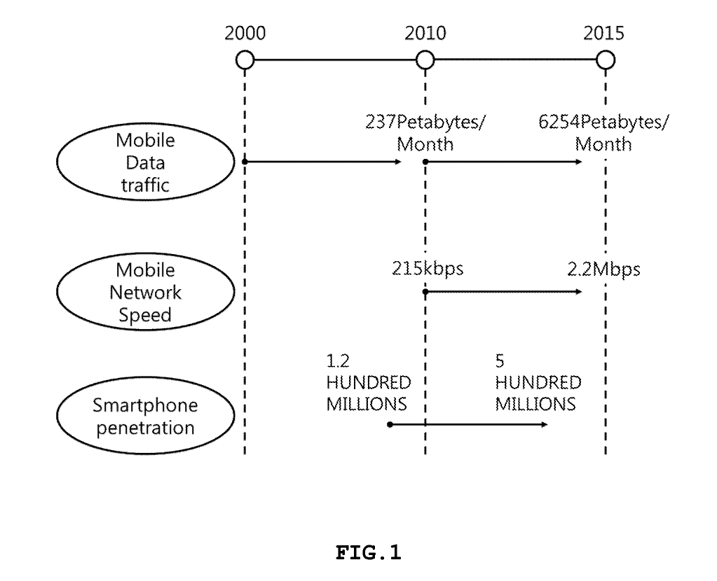

FIG. 2 shows main causes that may cause prior mobile network jam.

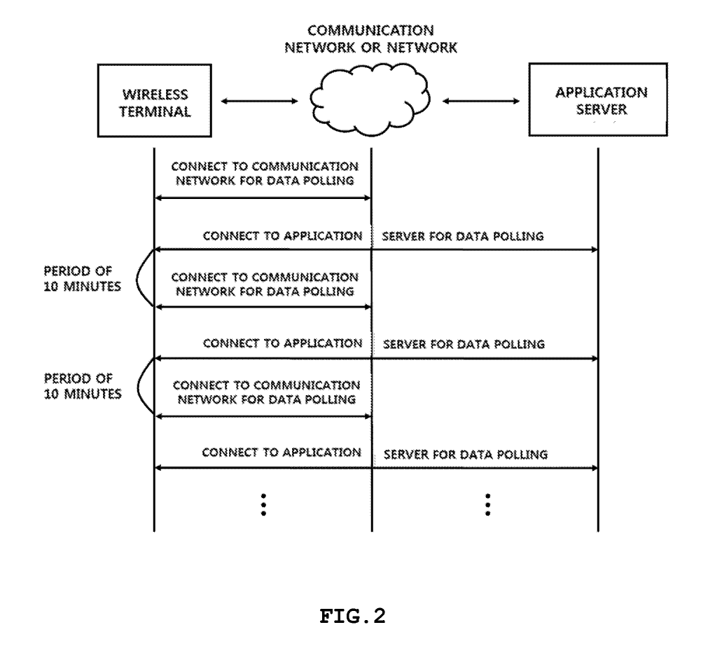

FIG. 3 shows the main configuration unit of a device for server grouping according to an embodiment of the present invention.

FIG. 4 shows one embodiment showing one of the preprocessing processes according to an embodiment of the present invention.

FIG. 5 shows one embodiment showing one of server alignment processes for each packet switching time for each wireless terminal according to an embodiment of the present invention.

FIG. 6 shows one embodiment showing one of the server alignment processes for each packet switching time for each wireless terminal according to an embodiment of the present invention.

FIG. 7 shows one embodiment showing one of the server alignment processes for each packet switching time for each wireless terminal according to an embodiment of the present invention.

FIG. 8 shows one embodiment showing one of the server alignment processes for each packet switching time for each wireless terminal according to an embodiment of the present invention.

FIG. 9 shows one embodiment showing one of server alignment processes for each packet switching time for each wireless terminal according to an embodiment of the present invention.

FIG. 10 shows one embodiment showing an example of extracting signatures of domain names according to an embodiment of the present invention.

FIG. 11 is an outline drawing for signature extraction processes according to an embodiment of the present invention.

FIG. 12 shows one embodiment showing an example of splitting signatures of domain names according to an embodiment of the present invention.

FIG. 13 shows one embodiment showing an example of merging signatures of domain names according to an embodiment of the present invention.

FIG. 14 shows one embodiment showing an example of composite grouping according to an embodiment of the present invention.

FIG. 15 shows one embodiment showing the result of the grouping according to an embodiment of the present invention.

FIG. 16 shows a first process of server pattern grouping according to an embodiment of the present invention.

FIG. 17 shows a second process of the server pattern grouping according to an embodiment of the present invention.

FIG. 18 shows server domain name grouping processes according to an embodiment of the present invention.

FIG. 19 shows composite grouping processes according to an embodiment of the present invention.

FIG. 20 shows grouping processes according to another embodiment of the present invention.

FIG. 21 and FIG. 22 are views for describing application matching according to an embodiment of the present invention.

FIG. 23 shows a flow chart for describing domain name grouping processes according to another embodiment of the present invention.

### DESCRIPTION OF THE PREFERRED EMBODIMENTS

Hereinabove, although the present invention is described by specific matters such as concrete components, and the like, embodiments, and drawings, they are provided only for assisting in the entire understanding of the present invention. The specified matters and embodiments and drawings such as specific apparatus drawings of the present invention have been disclosed for illustrative purposes, but are not limited thereto, and those skilled in the art will appreciate that various modifications, additions and substitutions are possible from the present invention in the art to which the present invention belongs. In describing exemplary embodiments of the present invention, well-known functions or constructions will not be described in detail since they may unnecessarily obscure the understanding of the present invention. Further, the terminologies specifically defined in consideration of the configuration and functions of the present invention may be construed in different ways by the intention of users and operators. Therefore, the definitions thereof should be construed based on the contents throughout the specification. Therefore, the definitions thereof should be construed based on the contents throughout the specification.

It will be apparent to those skilled in the art that substitutions, modifications and variations can be made without departing from the spirit and scope of the invention as defined by the appended claims and can also belong to the scope of the invention.

Hereinafter, device for server grouping 100 will be described in more detail according to the embodiment of the present invention.

<Server Grouping Using Time Adjacency and Other Conditions>

In order to detect specific services or specific applications that cause overload at a communication network, there is a need for blocking or controlling connection of the specific services or specific applications for servers that cause overload by grouping the servers performing packet switching for each specific service or specific application.

Further, the servers generally providing the specific services or specific applications are not specified as a single server and a plurality of servers are communicated using composite schemes for one application, and therefore there is a problem that is difficult to analyze whether causes generating traffics are in which applications or services when traffics are generated by some servers. Therefore, the servers may be efficiently managed by grouping the servers generating the traffics for each service or application.

In order to solve this need, the device for server grouping 100 in the embodiment of the present invention processes packets causing the overload at the communication network according to various criteria and kinds, and may identify the servers as the objects transmitted with each packet.

Further, the device 100 for server grouping groups the identified servers 300 into a plurality of sets according to predetermined criteria, and may group the servers associated with each service or application after corresponding each group to the specific services or applications and classifying them. Therefore, it is possible to monitor the traffics generated for each service or application or to correctly establish blocking or controlling policies corresponded to each service or application, thereby to efficiently manage the traffics.

When the device 100 for server grouping groups the servers 300 using various schemes, the time adjacency between the packets may be preferentially considered. For example, when one wireless terminal 200 communicates with an application server 300, patterns of the transceived packet(s) may be found within predetermined predetermined time in communication processes on analyzing packet flow. In this case, the device 100 for server grouping may identify address information of the servers 300, transceiving the packets, connected with the wireless terminal 200, during predetermined time based on time interval between each packet, wherein the address information, for example, may be domain name or IP.

Then, the device 100 for server grouping may estimate that the wireless terminal 300 is operated by one application and communicates with the servers 300. When IPs of the servers 300 found from timely adjacent packets are present, it may be estimated that the servers 300 belongs to the same application.

Further, the device 100 for server grouping collects or captures the packets transceived between a plurality of wireless terminals 200 and a plurality of servers 300 on subjecting to this estimation and may group the servers 300 to be identified by the time adjacency. The grouped servers 300 may be classified for each service or application according to predetermined criteria, and it is possible to establish traffic monitoring and traffic blocking or controlling policy for each service or application based on the result of classifying.

To this end, the device 100 for server grouping connects the servers 300 identified from the packets and may produce relationship form information for the connected servers 300. The relationship form information may be implemented as graphic objects or data that, for example, a plurality of servers 300 become nodes and degree or value of relationship between each server 300 become edges, and the device 100 for server grouping stores, outputs and manages the produced relationship form information.

The device 100 for server grouping identifies all servers 300 communicating with one wireless terminal 200 to produce the relation form information, identifies the servers 300 on communicating between all the wireless terminals 200 and servers 300 by iteratively performing the identification on all the wireless terminals 200, and may extract server pairs for producing the relationship form information according to the time adjacency.

For example, the device 100 for server grouping collects the packets transceived to the servers 300 communicating with one wireless terminal 200, that is, the servers A and B, estimates transceiving packets by one service or application up to the predetermined maximum time y when the packets having the time interval between the packets within time x are successively present, and may configure the object thereof, that is, the servers 300 (A and B) as one pair (two servers appearing within time section y). Further, the device 100 for server grouping may gather server pairs throughout the network by magnifying this into all the wireless terminals 200, and identifies the number of the servers 300 appearing within a specific time section based on the number of the gathered server pair as a result and may operate the number of the relationship between each server.

Further, edge values of the relationship form information may be determined based on the time interval of a pair of servers appearing from entire time section according to relative time adjacency. For example, the device 100 for server grouping may use the number of times being appeared for first server pairs within predetermined time interval and the number of times being appeared for first server pairs having intervals larger than predetermined time interval on determining edge values of first server pairs. The device 100 for server grouping increases the edge values between the first server pair by 1 when the first server pair within the predetermined maximum time interval y is detected and decreases the edge values between the first server pair by 1 when another first server pair above the predetermined maximum time interval y is detected such that final edge values reflecting the relative adjacency may be determined. A relationship degree or value may be calculated according to the determined edge values, and the relationship form information may be produced.

The device 100 for server grouping produces the relationship form information based on the number of the gathered server pair, operates the relationship degree or value between the servers based on the relationship form information, and groups the servers having high relationship degree or value into each group.

On the other hand, problems, in that the specific server (for example, Google server, etc.) to be dominantly appeared and another servers belong to one group, may be caused on simply processing by absolute number of the server pairs, thereby to decrease accuracy and reliability.

Therefore, the device 100 for server grouping in the embodiment of the present invention may further perform a step for determining the relative relationship degree or value between each server pair using the absolute number to be appeared for the specific server 300 found from the server pairs or the absolute number of the time section included in the specific server 300, on calculating the relationship degree or value based on the number of the server pairs, to operate more accurate relationship degree or value.

For example, in the device 100 for server grouping in the embodiment of the present invention, the relative relationship degree or value to the server A at the server n may be determined as 100/10000, that is, 0.01 when the server pairs of one hundred between the server n and the server A are found and the number of the server A to be appeared of the entire server pairs is 10000. On the other hand, the relative relationship degree or value to the server A at the server n is determined as 100/100, that is, 1 in the device 100 for server grouping, when the server pairs of one hundred between the server n and the server A are found and the number of the server A to be appeared of the entire server pairs is 100, such that it may be determined that the latter has higher association. This may remove noise, etc. caused by specific sharing servers that relatively appear frequently irrespective of applications.

On the other hand, on calculating the relative relationship degree or value using the absolute number to be appeared of the servers, relative importance between each servers may be estimated, but having more the number of the server pairs may not reflect enhancement of the reliability caused by enhancement of the number of sample.

For example, when basic relationship degree or value (the absolute number to be appeared) of the server pairs A−n is 200 and the relative relationship degree or value is 0.1, and the relationship degree or value of the server pairs n−B is 10000 and the relative relationship degree or value is 0.1, it may be determined that the reliability of the relationship degree or value for the latter is higher.

Therefore, the device 100 for server grouping performs arithmetic operation applying to the relative relationship degree or value on having the entire number to be appeared of each server pairs as sample values, and may acquire statistical relationship values reflecting the sample values. The device 100 for server grouping may adequately group the servers 300 based on the statistical relationship values.

The degree or value reflecting the entire number (the number of samples) to be appeared of the server pair for the statistical relationship values may be determined by the predetermined adaptation values. A scheme for applying the statistical relationship values may use various schemes using general statistics. For example, the device 100 for server grouping may calculate the statistical relationship values by an formula such as (the number of the sample*the relative relationship degree or value)/(the number of the sample+adaptation values). The higher the adaptation values in the formula, the more reflective the entire number to be appeared of the server pairs, and the device 100 for server grouping may already set the adaptation values.

In addition, the device 100 for server grouping finally produces the above-described relationship form information based on the statistical relationship values, and may group a plurality of servers by modularizing the relationship form information. As described above, the relationship form information may be produced as graph data that a plurality of servers become nodes and the statistical relationship values become edges.

On the other hand, the device 100 for server grouping may remove the edges below constant values from data having the produced relationship form information. Therefore, the device 100 for server grouping may remove noises firstly having too small values, and may divide optimal server groups from the relationship form information removed with noises.

But, the removed noises may be used again by the result grouped later. Therefore, the device 100 for server grouping again analyzes the server pairs connected to the edges removed above on completing grouping by modularity, and may further perform a step for allocating to adaptable server groups.

Further, the above-described relative relationship values and the statistical relationship values may be selectively used from case to case. Therefore, the device 100 for server grouping performs the server grouping based on network use pattern information, connects the servers appeared within predetermined time sections by pairs from the packets extracted from the network use pattern information and counts the pairs calculates the number of the relationship between the servers, applies at least one of the absolute number to be appeared of each server or the absolute number to be appeared of the server pairs to the number of the relationship between the servers calculates the relative or statistical relationship values, and may group the servers 300 into at least one group by the relationship form information produced based on the relative or statistical relationship values.

On the other hand, the device 100 for server grouping interlocks with the time adjacency and another various schemes to be described below and complexly groups the servers 300, and may classify the grouped servers according to the applications or services. Detailed classifying schemes and implementing examples will be described hereinafter.

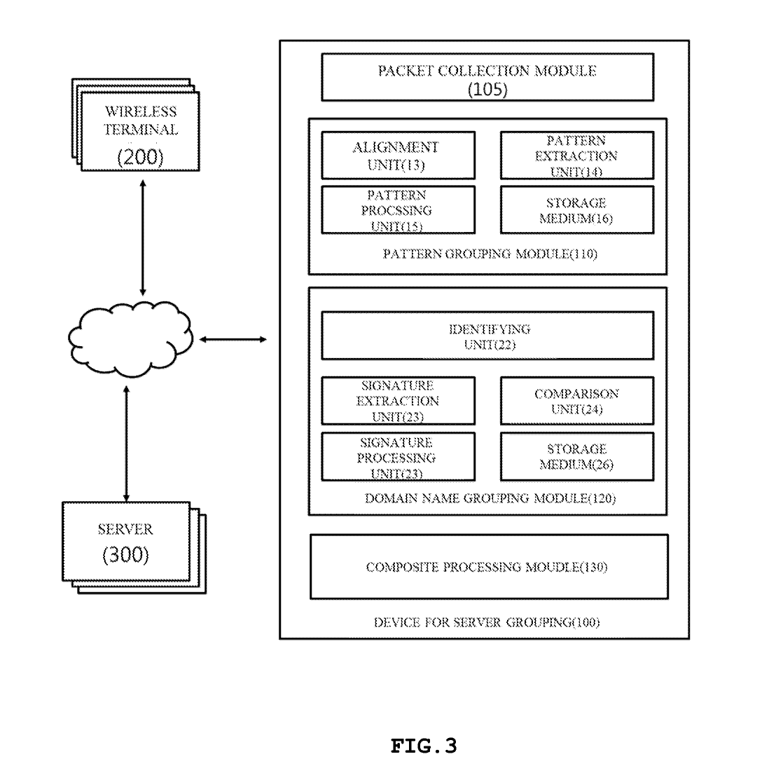

FIG. 3 shows the main configuration unit of a device 100 for server grouping according to an embodiment of the present invention.

In more detail, FIG. 3 shows configurations that a plurality of wireless terminal 200 and servers 300 are connected to communication networks or networks for transceiving (switching) the packets and collects or captures the packets, and groups the servers 300 for each specific services or specific applications.

According to one embodiment of the present invention, the server grouping module 161 collects or captures a plurality of packets for mutually transceiving between a plurality of wireless terminal 200 and servers 300 through the communication network, connects the collected or captured packets and packet collection or capture time information (or packet switching time information) to the subject and the object of each packet transceiving, that is, identification information of each wireless terminal 200 and address information of each server 300 and maps the connected them, aligns the address information of a plurality of servers 300 connected within the predetermined time for each wireless terminal 200 to the mapped packets for each packet collection or capture time, connects a first server 300, a second server 300, n-th (n=3, 4, . . . n) server 300 connected with the wireless terminals 200 within the predetermined time for each packet collection or capture time using the aligned information, counts the number N of the wireless terminals 200 equally connecting each server 300 or the number N of the time sections appeared with the wireless terminals 200 equally connecting the servers 300, and groups a plurality of servers 300 for connecting the servers 300, having the counted number N of the wireless terminals 200 or the number N of the time sections appeared with the wireless terminals 200 equally connecting the servers 300 larger than the predetermined number N′, into the group of the servers 300 corresponding to a single service or application.

Further, the device 100 for server grouping collects or captures a plurality of packets for mutually transceiving between a plurality of wireless terminals 200 and servers 300 through the communication network, identifies domain names of, the subject or the object transceiving the collected or captured packets, that is, the servers 300, extracts signatures of the identified domain names, compares the signatures extracted by a recording medium 26 for storing the predetermined inherent signatures with inherent signatures pre-stored in the recording medium 26, splits or merges or splits and merges the extracted signatures in response to the compared result, and groups the servers 300 corresponding to the same signatures of the split or merged or split and merged signatures into the group of the servers 300 corresponding to the single service or application.

In addition, when the signatures of the servers grouped by pattern grouping are matched with at least one of the signatures of the servers grouped by domain name grouping, the device 100 for server grouping moves the servers, including the signatures to be matched, of the servers grouped by the pattern grouping into the servers grouped by the domain name grouping and complexly processes grouping.

Further, the device 100 for server grouping compares the address information of the grouped servers 300 with the address information of the servers 300 stored on storage mediums 16 and 26 by the storing mediums 16 and 26 connecting and storing the address information of at least one servers 300 for each service or application, and sets the grouped servers 300 to the servers 300 connected with the services or applications linked with addresses of the servers 300 matched on the storage mediums 16 and 26, when at least one of the address information of the grouped servers 300 is matched with the address information of the servers 300 stored on the storage mediums 16 and 26, according to the result of comparison.

The device 100 for server grouping in the present invention filters and excludes the packets for commonly transceiving to a plurality of services or applications of the collected or captured packets wherein the packets for commonly transceiving include an advertisement packet or charging packet.

In addition, the device 100 for server grouping in the present invention identifies the domain names corresponding to the addresses of the grouped servers 300 using the address information and a domain name table of the servers 300 derived by DNS (Domain Name System) protocol analysis.

Referring to FIG. 3, the device 100 for server grouping in the embodiment of the present invention includes a packet collection module 105, a pattern grouping module 110, a domain name grouping module 120, and a composite processing module 130, the pattern grouping module 110 includes an alignment unit 13, a pattern extraction unit 14, a pattern processing unit 15, and a storage medium 16, and the domain name grouping module 120 includes a identifying unit 22, a signature extraction unit 23, a COMPARISON UNIT 24, a signature processing unit 25, and a storage medium 26.

The device 100 for server grouping is shown as a single device 100 in the drawing for the description of the embodiments, but each configuration may be separated into at least one device or server.

Further, each configuration of the pattern grouping module 110 and domain name grouping module 120 may be separated from each other, or may be configured by a common configuration section.

The storage medium 16 and 26 may be configured by a single storage medium, and the pattern extraction unit 14 and signature extraction unit 23, the pattern processing unit 15 and signature processing unit 25 may be also configured as the common configuration section.

Referring to FIG. 3, the packet collection module 105 collects or captures a plurality of packets for mutually transceiving between a plurality of wireless terminals 200 and servers 300 through the communication network.

When the wireless terminals 200 communicate with the servers 300 (for game, web, chatting and YouTube) in the embodiment of the present invention, packets produced from the wireless terminals 200 are converted into TCP/IP protocol and therefore transferred to the corresponding server 300 on passing the mobile communication company's system (for example, network processing apparatuses such as GGSN (Gateway GPRS Support Node) or P-Gateway). Since the packets should be analyzed without causing communication problems between the wireless terminals 200 and the servers 300, the packet collection module 105 duplicates the packets and it is desirable that the duplicated packets are transferred to the packet collection module 105. Further, communication equipments to be described below are modified for in-line processing.

Further, the packet collection module 105 of the present invention connects the collected or captured packets and the packet collection or capture time information (or the packet switching time information) to the subject and the object transceiving each packet, that is, the address information (IP/port information etc.) of each wireless terminal 200 IP (Internet Protocol) and server 300 and maps the connected them.

As described above, the packets transceiving between the wireless terminals 200 and servers 300 in the communication network are mixed in the packets communicating between a plurality of the wireless terminals 200 and servers 300, and therefore the packets should be firstly classified for each wireless terminal 200 communicating with the servers 300 to grasp rules between the packets transceiving between a specific wireless terminal 200 and a specific server 300. Therefore, the packet collection module 105 connects the collected or captured packets and packet collection or capture time information to the subject and the object of transceiving each packet, that is, each wireless terminals 200 IP and servers 300 IP/port and maps the connected them.

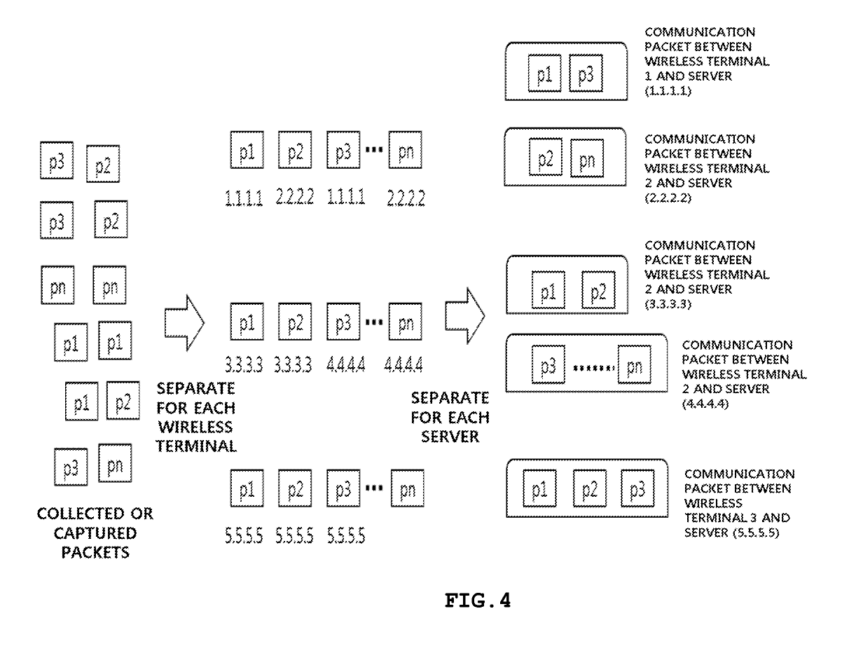

FIG. 4 shows that the packet collection module 105 connects the collected or captured packets to the subject and the object transceiving each packet, that is, IP of each wireless terminal 200 and IP/PORT of server 300 and maps the connected them.

In FIG. 4, in order to classify the packets transceiving between a plurality of wireless terminals 200 and servers 300 for each specific wireless terminals 200 and servers 300 communicating with the specific wireless terminals 200, the packet collection module 105 may firstly classify a plurality of packets for each IP of the wireless terminals 200 and secondly classify each packet for each server 300, using IP/PORT of packet source and IP/PORT of destination written in the packets, to send the packets from the specific wireless terminals 200 to the servers 300.

On sending the packets from the wireless terminals 200 IP 1.1.1.1/PORT 10 to the servers IP 2.2.2.2/PORT 20, 1.1.1.1 is written in a source field of IP header of the packets, and 2.2.2.2 is written in a destination field. Similarly, when 10 is written in the source of TCP (or UDP) header, 20 is written in the destination. When the source and destination are written in the packets and the packets are transferred to various routers or switches, the packets are transferred to another routers or switches while referencing the corresponding fields of the packets and it is possible to classify whether from where do these packets come from to where are these packets going on analyzing these fields.

The specific applications of the wireless terminals 200 connect to servers 300 to perform the communication. Accordingly, when the communication packets are collected or captured after passing GGSN via a base station, the packet collection module 105 is classified for each IP and PORT due to the jam such as FIG. 4 and may restore original structures.

Further, the packet collection module 105 may classify the collected or captured packets for each IP/PORT of the servers 300 and IP of the wireless terminals 200.

To this end, the packet collection module 105 must know whether which address is the IP of the servers 300 and is the IP of the wireless terminals 200. Therefore, the packet collection module 105 receives band information of the wireless terminal 200 IP from a server of the communication company, identifies whether which values of Source or Destination of the packets are the wireless terminal 200 IP, and may determine IP different from it as the server 300 IP.

Further, the packet collection module 105 of the present invention filters and excludes the packets commonly transceiving to a plurality of services or applications of the collected or captured packets. Further, the packet collection module 105 of the present invention filters and excludes the packets commonly transceiving to a plurality of services or applications of the collected or captured packets. In this case, the packets for commonly transceiving include an advertisement packet or charging packet.

On the other hand, according to one embodiment of the present invention, the pattern grouping module 110 aligns the address information of a plurality of servers connected within the predetermined minimum time for each wireless terminal 200 to the mapped packets for each packet collection or capture time, connects a first server, a second server, n-th (n=3, 4, . . . n) server connected with the wireless terminals within the predetermined time for each packet collection or capture time using the aligned information, counts the number N of the wireless terminals equally connecting each server or the number N of the time sections appeared with the wireless terminals equally connecting servers 300, and groups a plurality of servers 300 for connecting the servers 300, having the counted number N of the wireless terminals or the number N of the time sections appeared with the wireless terminals 200 equally connecting the servers 300 larger than the predetermined number N′, into the group of the servers corresponding to a single service or application. Hereinafter, each configuration will be described.

The alignment unit 13 in the embodiment of the present invention aligns the address information of the servers 300 connected within the predetermined time for each wireless terminal 200 to the mapped packets for each packet collection or capture time.

It is desirable that the predetermined time is set to predetermined time length unit, but it is possible to set it to different unit according to technology development and transform. According to one embodiment of the present invention, the pattern extraction unit 14 connects a first server 300, a second server 300, n-th (n=3, 4, . . . n) server 300 connected with the wireless terminals 200, within the predetermined time for each packet collection or capture time, using information assigned by the alignment unit 13, and counts the number N of the wireless terminals 200 equally connecting each server 300 or the number N of the time sections appeared with the wireless terminals 200 equally connecting the servers 300.

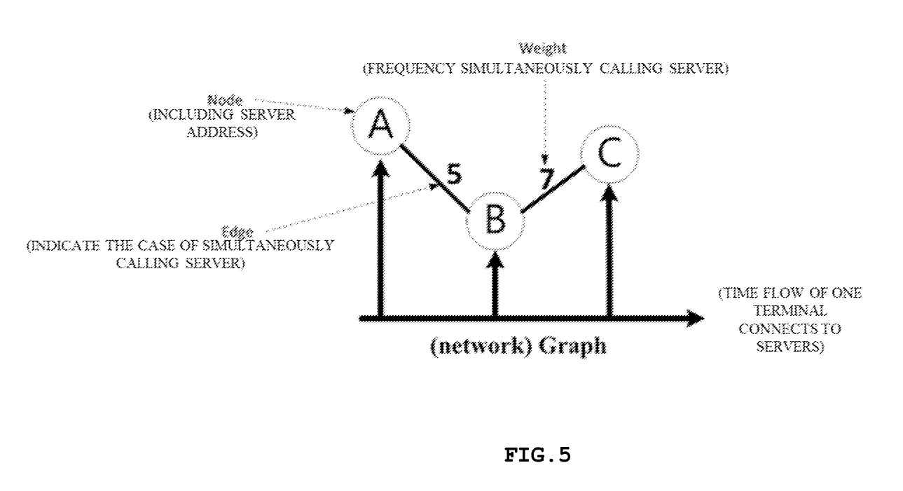

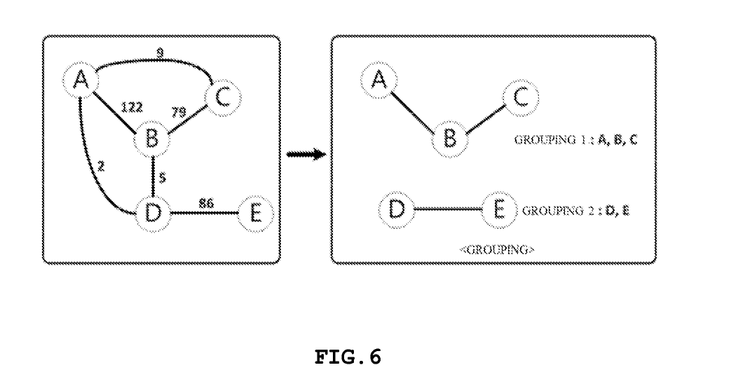

FIG. 5 and FIG. 6 show that the alignment unit 13 and pattern extraction unit 14 aligns the address information of the servers 300 connected within the predetermined time for each wireless terminal 200 to the mapped packets for each packet collection or capture time, and counts the number N of the wireless terminals 200 equally connecting each server 300 or the number N of the time sections appeared with the wireless terminals 200 equally connecting servers 300.

FIG. 5 represents the address information of the servers 300 connected within the predetermined time for each wireless terminal 200 by a graph.

Wherein, a node, which is an element that is the target of the relationship in the graph, represents the address of the server 300, and the address of the server 300 is an IP address basically including port numbers.

Further, an edge represents the relationship between nodes and is represented as a pair of the address of two servers 300, that is, “server's address A” and “server's address B”, and the address of former server 300 is a source node of the edge and the address of latter server 300 is a destination node.

Further, a weight represents a relationship degree or value between two nodes, that is, the number of the wireless terminal 200 simultaneously calling the corresponding server 300 to the edge.

FIG. 5 shows that the wireless terminals 200 connect to the server B almost immediately (within the predetermined minimum time) on connecting to the server A and connect to the server C almost immediately after connecting to the server B, and that the number of the wireless terminals 200 connecting to the server B almost immediately on connecting to the server A is 5 and the number of the wireless terminals 200 connecting to the server C almost immediately on connecting to the server B is 7.

Referring to FIG. 6, when the wireless terminals 200 are connected to the server A and the servers 300 to be almost immediately connected includes a server B, a server D and a server C, it is connected to the server C and server D almost immediately after connecting to the server B and it is connected to the server E after connecting to the server D.

Further, the number of the wireless terminals 200 almost immediately connecting to the server B on connecting to the server A is 122, the number of the wireless terminals 200 almost immediately connecting to the server D on connecting to the server A is 2, the number of the wireless terminals 200 almost immediately connecting to the server C on connecting to the server A is 9, the number of the wireless terminals 200 almost immediately connecting to the server C on connecting to the server B is 79, the number of the wireless terminals 200 almost immediately connecting to the server D on connecting to the server B is 5, and the number of the wireless terminals 200 almost immediately connecting to the server E on connecting to the server D is 86.

The alignment unit 13 is based on result values at a graph shown in FIG. 5, the pattern extraction unit 14 counts the number N of the wireless terminal 200 equally connecting each server 300 or the number N of the time sections appeared with the wireless terminal 200 equally connecting the servers 300, and the pattern processing unit 15 groups a plurality of servers 300 for connecting the servers 300 having the number N of the wireless terminals 200 larger than the predetermined number N′ based on the counted result into the group of the servers 300 corresponding to a single service or application.

Referring to FIG. 6, when the pattern extraction unit 14 counts the number N of the wireless terminal 200 for equally connecting each server 300 to 122, 79, 5, 9, 2 and 86 and the predetermined number N′ is 50, the pattern processing unit 15 groups the server A, the server B and the server C having the number, counted by the pattern extraction unit 14, larger than the predetermined number N′ into one group and groups the server D and the server E into one group.

The pattern processing unit 15 in the embodiment of the present invention groups a plurality of servers 300 connecting each server 300 having the number N of the wireless terminals 200 or the number N of the time sections appeared with the wireless terminals 200 for equally connecting the servers 300, counted by the pattern extraction unit 14, larger than the predetermined number N′ into the group of the servers 300 corresponding to a single service or application.

Further, the pattern processing unit 15 compares the address information of the grouped servers 300 with the address information of the servers 300 stored on storage mediums 16 and 26 by the storing mediums 16 and 26 connecting and storing the address information of at least one servers 300 for each service or application, and sets the grouped servers 300 to the servers 300 connected with the service or application linked with addresses of the servers 300 matched on the storage mediums 16, when at least one of the address information of the grouped servers 300 is matched with the address information of the servers 300 stored on the storage mediums 16, according to the result of comparison.

In addition, the pattern processing unit 15 identifies the domain names corresponding to the addresses of the grouped servers 300 using the address information and a domain name table of the servers 300 derived by DNS (Domain Name System) protocol analysis.

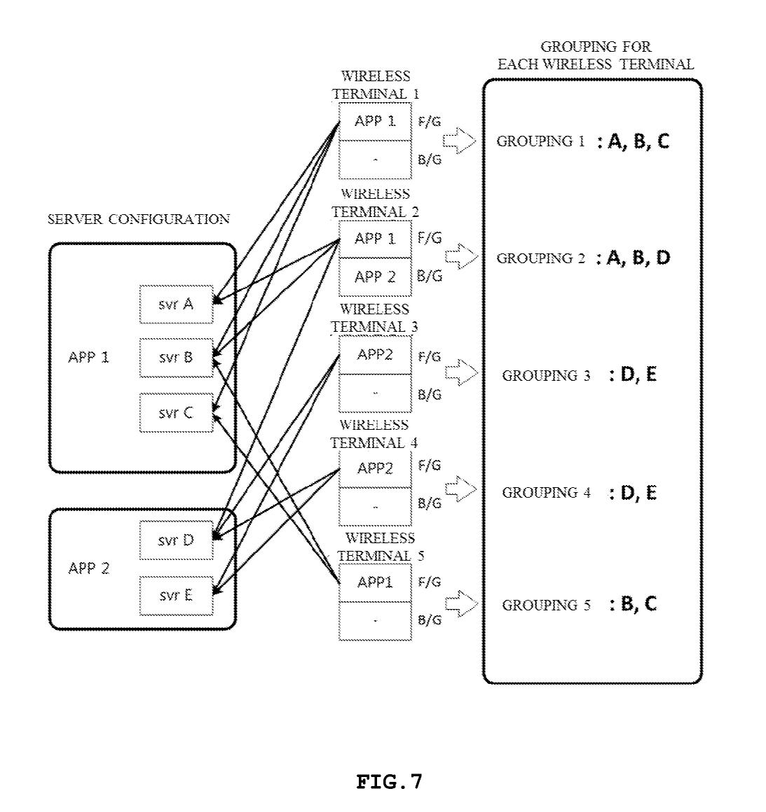

FIG. 7 to FIG. 9 shows that the pattern processing unit 15 groups a plurality of servers 300 connecting each server 300 having the number N of the wireless terminals 200 or the number N of the time sections appeared with the wireless terminals 200 equally connecting the servers 300, counted by the pattern extraction unit 14, larger than the predetermined number N′ into the group of the servers 300 corresponding to a single service or application.

In grouping processes of the pattern processing unit 15, the servers 300 connected within the predetermined time for each wireless terminal 200 are firstly grouped as shown in FIG. 4 and then the grouping for each wireless terminal 200 is secondly connected like the graph shown in FIG. 5.

Further, the number of the wireless terminals 200 almost immediately connecting to the server B on connecting to the server A is 2, the number of the wireless terminals 200 almost immediately connecting to the server D on connecting to the server A is 1, the number of the wireless terminals 200 almost immediately connecting to the server C on connecting to the server A is 1, the number of the wireless terminals 200 almost immediately connecting to the server C on connecting to the server B is 2, the number of the wireless terminals 200 almost immediately connecting to the server D on connecting to the server B is 1, and the number of the wireless terminals 200 almost immediately connecting to the server E on connecting to the server D is 2.

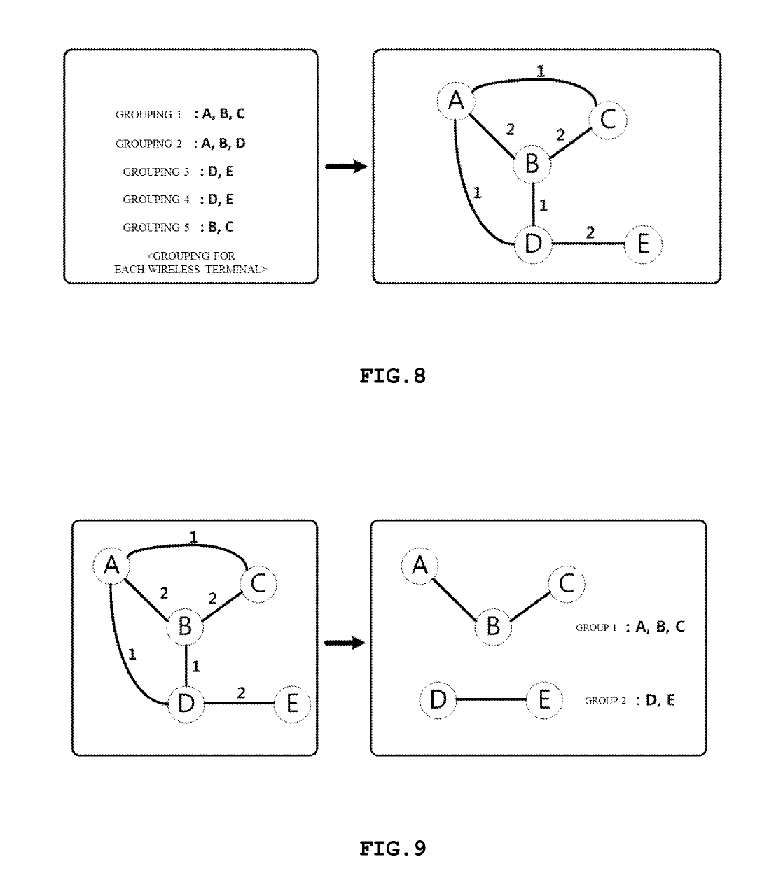

FIG. 8 schematically shows the connection between the servers through total 5 wireless terminals 200 to facilitate understanding of the present invention, and the result of FIG. 7 is acquired in case of expanding it.

On grouping the case that the number of the wireless terminals 200 is at least two, based on the result of the graph shown in FIG. 8, the pattern processing unit 15 may group the server A, the server B and the server C into one group and group the server D and the server E into one group, as shown in FIG. 6.

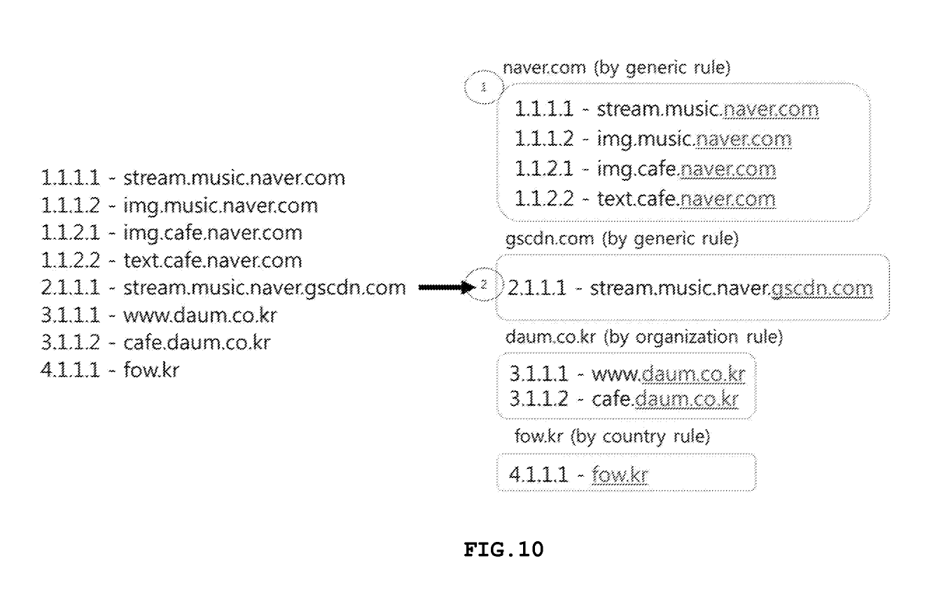

FIG. 9 shows that the pattern processing unit 15 compares the group of the grouped servers 300 with the servers 300 on the storage medium 16 connecting and storing the address information of at least one server 300 for each specific service or specific application and sets the grouped servers 300 to the servers 300 connected with the services or applications connected to the addresses of the servers 300 matched on the storage medium 16.

When the addresses of the servers 300 connected with the specific application (for example, Kakao Talk) already known on the storage medium 16 are the server A, the server B and the server C and the group of the servers 300 grouped by the pattern processing unit 15 are the server A, the server B, the server D, the server E and the server F, the server A and the server B of the group of the servers 300 are matched with the server A and the server B, connected with Kakao Talk, on the storage medium 16, and the servers 300 connected with Kakao Talk may be set to the group of the servers 300, including already known server A, server B and server C, and additive server D, the server E and the server F, connected with Kakao Talk.

The storage medium 16 stores the address information of the servers 300 already identified or known for each specific service or application.

FIG. 9 shows that the servers 300 derived by the pattern grouping are set to the servers 300 connected with the specific service or application, the servers 300 derived by the domain name grouping are set to the servers 300 connected with the specific service or application, or servers 300 derived by the composite grouping are set to the servers 300 connected with the specific service or application.

The object of the traffics, that is, the servers may be grouped using time adjacent pattern information of wire/wireless traffics by the server grouping method according to the embodiment of the present invention as above. Therefore, the servers may be managed for each server group and may efficiently automate works such as giving attributes to each group and application/service set classification.

Hereinafter, the embodiment for deriving connection relationship between the servers 300 will be described in more detail on grouping the server according to the embodiment of the present invention.

As shown in FIG. 5 to FIG. 9 described above, the relationship form information using the graph may be used as basic data for determining whether the connections between the servers 300 are the same. The relation form information may include at least one of edge information, node information and weight information shown in FIG. 5. For example, the pattern processing unit 15 may perform the grouping processing using the relationship form information produced from the alignment 13 and pattern extraction unit 14.

One server set produced from the same terminal may be illustrated as the smallest unit configuring the relationship form information. Further, the smallest unit produced from the relationship form information may include two server information sets produced from the same terminal. Two server sets may be represented by server pairs, and hundreds of the server pairs may be derived even at very short random time sections. The relationship between the server pairs may be represented by the relationship form information.

Further, various graph modeling method may be used to produce the relationship form information. The graph modeling method may use the graph modeling method connecting two server pairs to tie wide range (coverage), and the graph modeling method, etc. connecting maximum server pairs frequently generated to emphasize accuracy may be used. The server pairs having high relationship degree or value on the graph at any way have high probability that belongs to the same application.

As shown in FIG. 5, the graph having G=(V,E) form connected by edges may be modeled based on the relationship form information between the server pairs. Further, the value (weight) may be assigned at each edge. The edge value (weight) may represent the relationship degree or value, and may have different values by a method designating the relationship degree or value.

For example, the edge value may designate relative values or absolute values according to the appearing number of the server pairs. When the absolute values are designated as the appearing number (or the number of appeared sections) of the server pairs for the terminal, the absolute appearing number may be high in case of the servers frequently appearing. To compare it with the relative value is proper in case of needing the comparison for server relationship for dividing individual services. The appearing frequency of the server pairs may be concentrated on the specific server (for example, Google Talk server, Android starting server) having popularity and many relationship.

Further, on determining the edge value as the relative value in one embodiment, total communication times of communication target servers may be considered. For example, when the specific server n is frequently connected to the server having high relative frequency such as Google, many different servers within analysis target packets are communicated with Google servers and therefore noises are caused in an analysis process and the reliability may be lost. Therefore, on applying the edge values of the server pairs, the servers having more important relationship with the server n, that is, the servers highly designating the edge values due to a high relationship degree or value may be distinguished from the Google servers by using the relative values, having total communication times of communication target servers as a numerator, no the absolute values.

On the other hand, the size of absolute parameters (the number of appeared terminals or the number of appeared time sections) may be considered on determining the edge values in one embodiment. For example, when the relative values for determining the edge values are similar, an arithmetic process using the size of the parameter as variables may be added. Therefore, the reliability may be improved on comparing the relationship between the servers.

Further, when the edge values are determined in one embodiment, the edge below the parameter is removed from the graph. If the edges having relatively small relation are included, a possibility causing the noises is high in the result of the grouping. This may be semantically same as a step removing the appearing frequency of each server pairs below constant values.

On the other hand, according to the embodiment of the present invention, the server grouping work as shown in FIG. 6 is completed, and then a step correcting it may be further performed. For this, the device 100 for server grouping may perform correction works such as works for again grouping the servers not included in the grouping, using original graph G=(V,E) not subjecting to noise removal. This is because some servers (ex, periodic servers, traffic high rank server, or the servers for successively exchanging the same IP or port at the same services) are excluded due to low relation while performing filtering works to reduce noises of the communication patterns by the preprocessing unit 20.

For example, the servers that are connected to the same group but excluded by the noises may be included in the group again. Further, each server connected to the same servers may be produced into new groups according to the relative relationship degree or value.

According to one embodiment of the present invention described above, the servers, that perform packet switching for each specific service or application, may be efficiently grouped. In addition, it is possible to efficiently detect the specific services or applications causing overload at the communication network and therefore it is possible to block or control unnecessary performance causing network loads for each specific services or applications. Further, this may optimally use the networks at a wireless terminal stage, and it is possible to minimize network expansion cost of mobile communication companies by optimization of network use.

On the other hand, a domain name grouping module 120 according to an aspect of the present invention identifies the subjection or objection transceiving a plurality of packets collected or captured by the packet collection module 105, that is, domain names of the servers, extracts signatures of the identified domain names, compares the extracted signatures with inherent signatures pre-stored in a storage medium by the storage medium storing the predetermined inherent signatures, splits or merges or splits and merges the extracted signatures in response to the compared result, and groups the servers corresponding to the same signatures of the split or merged or split and merged signatures into the group of the servers corresponding to the single service or application.

A identifying unit 22 according to an aspect of the present invention identifies the subjection or objection transceiving the packets collected or captured by the packet collection module 105, that is, the domain names of the servers 300.

In addition, the identifying unit 22 in the present invention identifies the domain names corresponding to the subjection or objection transceiving the packets, that is, the addresses of the grouped servers 300 using the address information and the domain name table of the servers 300 derived by DNS (Domain Name System) protocol analysis.

A signature extraction unit 23 according to an aspect of the present invention extracts the signatures of the domain names identified by the identifying unit 22.

The signatures that extract characteristic parts only becoming representatives of the entire domain names may be used as main key values grouping the servers 300.

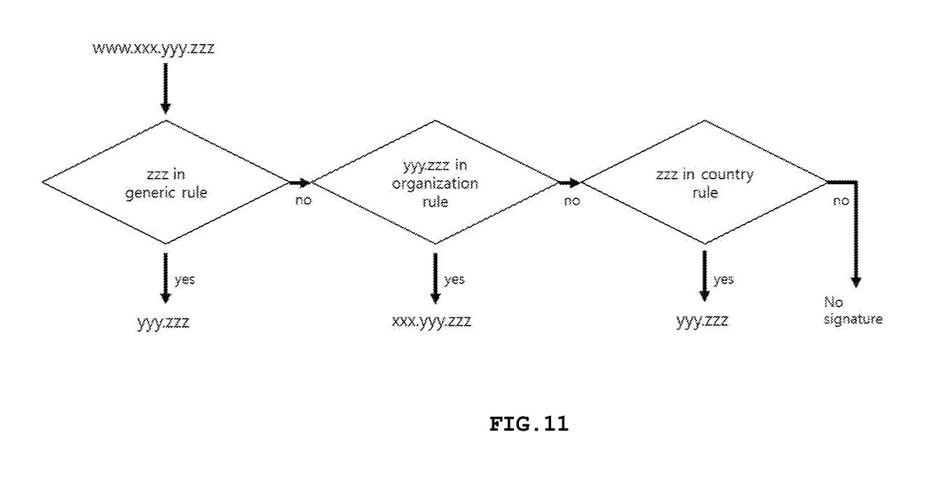

FIG. 10 is one embodiment showing an example of extracting the signatures of the domain names by the signature extraction unit 23.

As shown in FIG. 10, when the domain names corresponding to the IP address of the servers, that is, 1.1.1.1˜4.1.1.1 are ‘stream.music.naver.com’, ‘img.music.naver.com’, ‘img.cafe.naver.com’, ‘text.cafe.naver.com’, ‘stream.music.naver.gscdn.com’, ‘www.daum.co.kr’, ‘cafe.daum.co.kr’, ‘fow.kr’, respectively, the signatures are extracted from up to the domains following a top level in the case (generic rule) that a top level domain is ‘com’ and the signatures of four domain names such as ‘stream.music.naver.com’, ‘img.music.naver.com’, ‘img.cafe.naver.com’, ‘text.cafe.naver.com’ become ‘naver.com’. The signatures are extracted from up to the domains secondly following a top level in the case (organization rule) that the top level domain is ‘kr’ and the domains following the top level are co, ac, . . . , the signatures of two domain names such as ‘www.daum.co.kr’, ‘cafe.daum.co.kr’ become ‘daum.co.kr’, the signatures are extracted from up to the domains following the top level in other cases (country rule), and the signatures of ‘fow.kr’ become ‘fow.kr’.

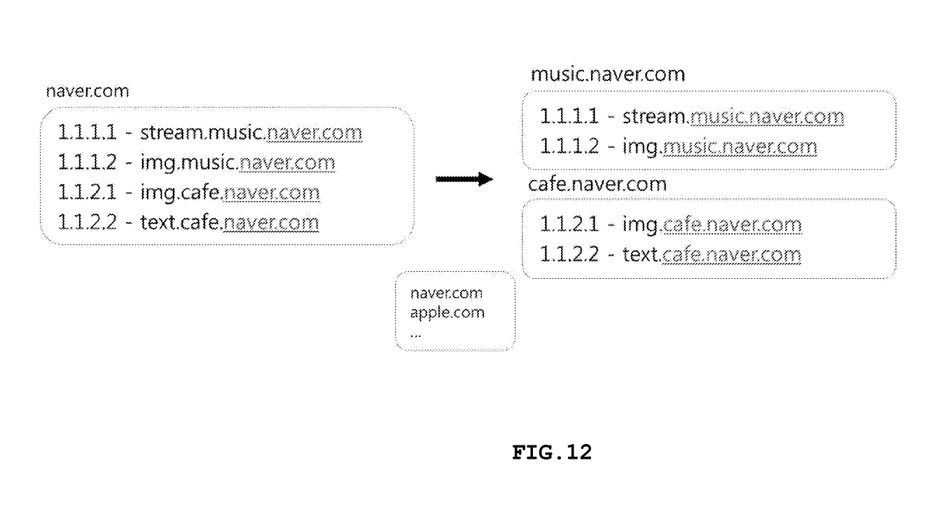

FIG. 11, that is an outline drawing for signature extracting processes according to an embodiment of the present invention, shows a method for extracting the signatures from the domain names.

Referring to FIG. 11, signature extraction orders are differently determined by the top level domain, wherein the signatures are defined up to the domains following the top level in the case (generic rule) that the top level domain is ‘com’, the signatures are defined up to the domains secondly following the top level in the case (organization rule) that the top level domain is ‘kr’ and the domains following the top level are co, ac, . . . , and the signatures are defined up to the domains following the top level in other cases (country rule).

The COMPARISON UNIT 24 according to one embodiment of the present invention compares the signatures extracted by the signature extraction unit 23 with inherent signatures prestored in the storage medium 26 by the storage medium 26 storing the predetermined inherent signatures (for example, gscdn.com, naver.com, apple.com, etc.), the signature processing unit 25 according to one embodiment of the present invention splits or merges or splits and merges the signatures extracted by the signature extraction unit 23 in response to the compared result of the COMPARISON UNIT 24, and groups the servers 300 corresponding to the same signatures of the split or merged or split and merged signatures into the group of the servers 300 corresponding to the single services or applications.

There are domain names that are not easy to mechanically distinguish, for example, a music application of “naver” at a service called “naver.gscdn.com” is executed by a global hosting company called gscdn on performing the grouping, wherein “naver.gscdn.com” services are equally recognized as “music.naver.com” and should perform the grouping.

Each signature extracted by the signature extraction unit 23 is split and/or merged in the COMPARISON UNIT 24 and signature processing unit 25, and then is determined as final signatures.

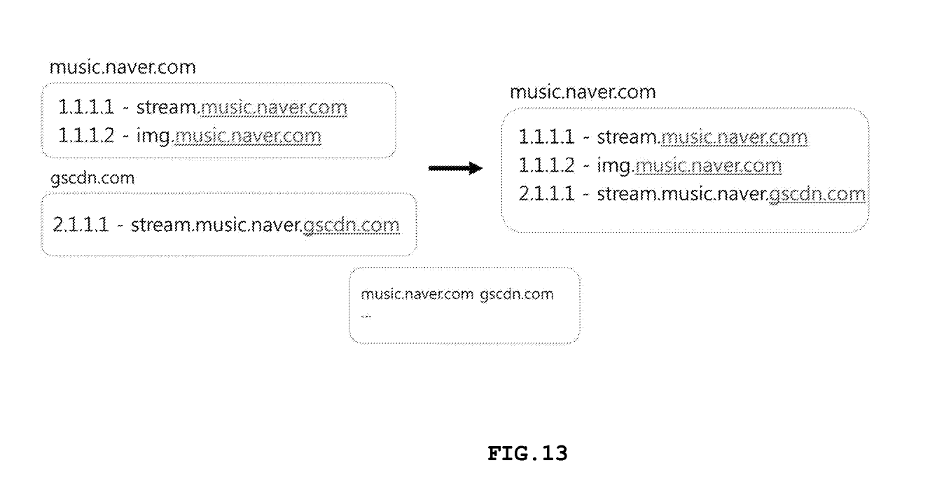

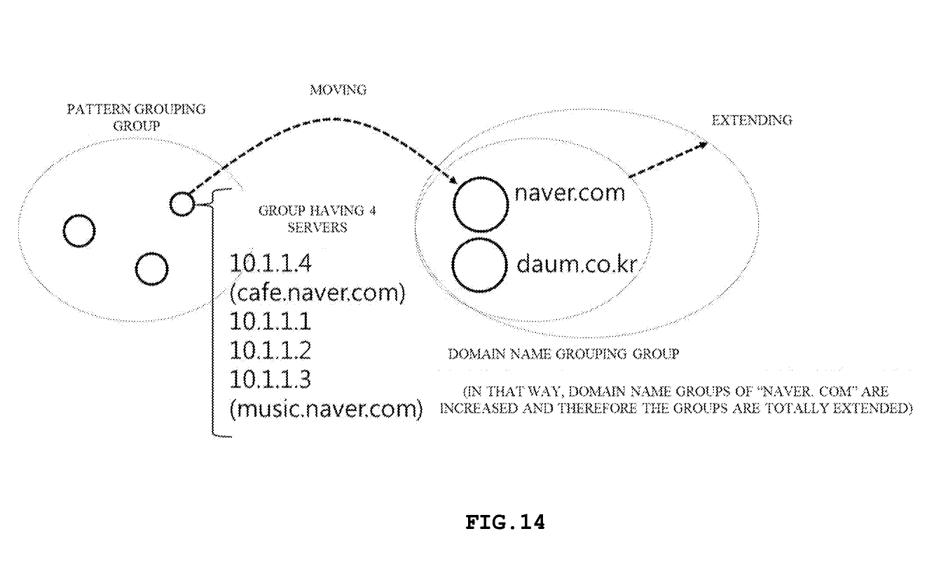

FIG. 12 and FIG. 13 is one embodiment splitting and merging each signature extracted by the signature extraction unit 23 in the COMPARISON UNIT 24 and signature processing unit 25.

FIG. 12 shows a splitting process. The signature extract section 23 may split the signatures predetermined and pre-stored on the storage medium 26 to classify the extracted signatures. For example, “naver.com” is sub-split into “music.naver.com, cafe.naver.com”, and the signatures more including the domain of one step as compared with the signatures made already after subjecting to split processing may be produced.

In the signatures extracted by the signature extraction unit 23, the signatures having four domain names such as ‘stream.music.naver.com’, ‘img.music.naver.com’, ‘img.cafe.naver.com’, ‘text.cafe.naver.com’ are extracted into ‘naver.com’ in the case (generic rule) that the top level domain is ‘com’, but ‘music.naver.com’ is split into more sub-spilt signatures in case of ‘stream.music.naver.com’, ‘img.music.naver.com’ and ‘cafe.naver.com’ is split into more sub-spilt signatures in case of ‘img.cafe.naver.com’, ‘text.cafe.naver.com’, after subjecting to split processes.

FIG. 13 shows a merging process wherein the signature extraction unit 23 may merge the extracted signatures into one signature. For example, “music.naver.com and gscdn.com” may produce one signature “music.naver.com” by merging, and a representative signature may be determined among the signatures pre-stored on the storage medium 26.

‘Music.naver.com’ is split into more sub-split signatures in case of ‘stream.music.naver.com’, ‘img.music.naver.com’ by the split process as shown FIG. 12 above. Further, ‘gscdn.com’ as an execution server at a global hosting company may be pre-stored on the storage medium 26 in case of ‘stream.music.naver.gscdn.com’ by a merging process as shown FIG. 13. Therefore, a signature ‘stream.music.naver.gscdn.com’ may be determined to ‘music.naver.com’ except the gscdn.

Finally, three domain names such as ‘stream.music.naver.com’, ‘img.music.naver.com’, ‘stream.music.naver.gscdn.com’ may be determined to the same signatures called ‘music.naver.com’, after subjecting to the split and merging process according to FIG. 12 and FIG. 13.

The signature processing unit 25 according to an aspect of the present invention groups the servers corresponding to the same signatures into the group of the servers corresponding to the single service or application, using the signatures determined in FIG. 12 and FIG. 13.

The signature processing unit 25 may set the group of the grouped servers 300 to the servers 300 connected with the services or applications connected to the addresses of the servers 300 matched on the storage medium 26.

When the addresses of the servers 300 connected with the specific application (for example, Kakao Talk) already known on the storage medium 26 are the server A, the server B and the server C and the group of the servers 300 grouped by the pattern processing unit 25 are the server A, the server B, the server D, the server E and the server F, the server A and the server B of the group of the servers 300 are matched with the server A and the server B, connected with Kakao Talk, on the storage medium 26, and the servers 300 connected with Kakao Talk may be set to the group of the servers 300 including already known the server A, the server B and the server C, and additive server D, the server E and the server F connected with Kakao Talk.

The storage medium 26 stores the address information of the servers 300 identified or known already for each specific service or application, the storage medium 26 for storing the predetermined inherent signatures (for example, gscdn.com, naver.com, apple.com, etc.) and the storage medium 26 for storing the address information of the servers 300 identified or known already for each specific service or application are shown as a single storage medium on the drawings, but the storage medium 26 for storing the predetermined inherent signatures (for example, gscdn.com, naver.com, apple.com, etc.) and the storage medium 26 for storing the address information of the servers 300 identified or known already for each specific service or application may be configured as a separate storage medium.

On the other hand, the composite processing module 130 according to an aspect of the present invention moves the servers including the signatures to be matched of the servers grouped by the pattern grouping module 110 into the servers grouped by the domain name grouping module 120 in the case that the signatures of the servers grouped by the pattern grouping module 110 are matched with at least one of the signatures of the servers grouped by the domain name grouping module 120 and compositely processes the grouping.

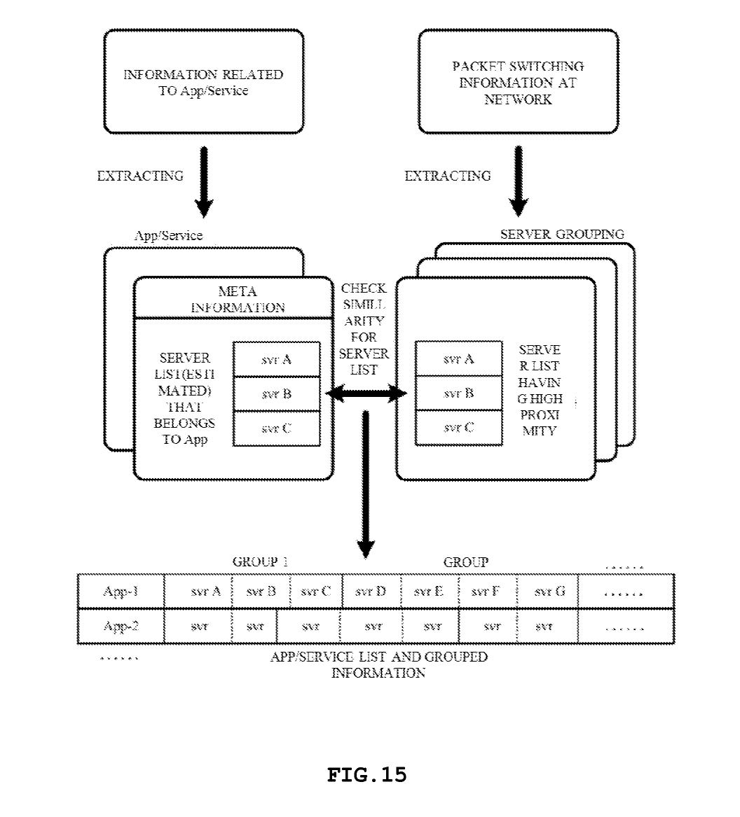

FIG. 14 shows an example that moves at least one of the servers grouped by the pattern grouping module 110 into the servers grouped by the domain name grouping module 120 through the composite processing module 130.

Four servers such as 10.1.1.4 (cafe.naver.com), 10.1.1.1/10.1.1.2/10.1.1.3 (music.naver.com) grouped by the pattern grouping module 130 moves into the server group ‘naver.com’ grouped by the domain name grouping module 120, thereby to extend the group of the domain names.

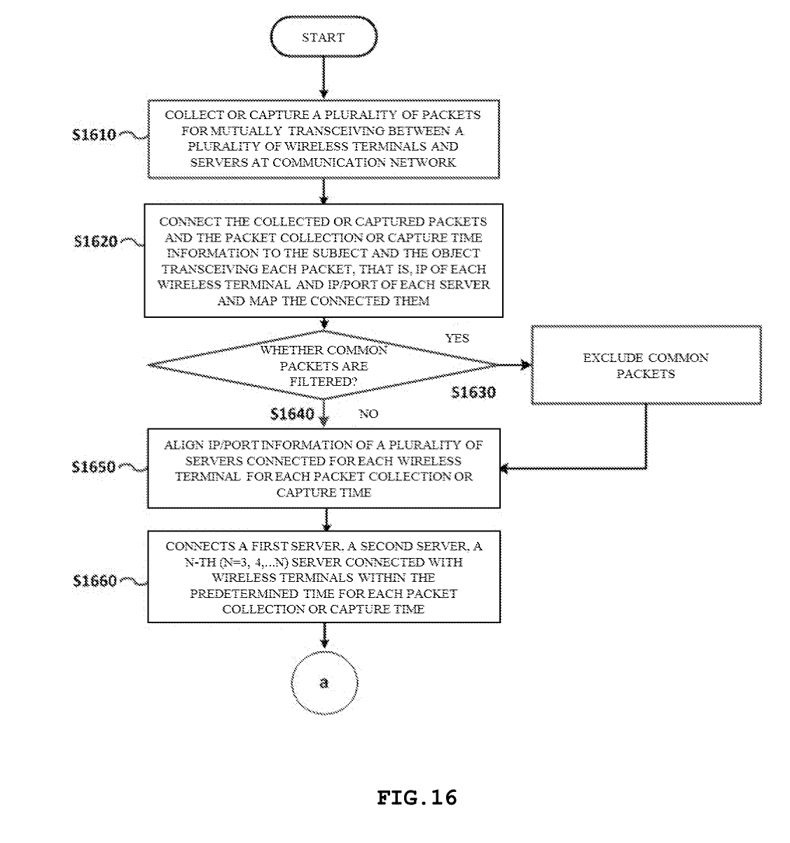

FIG. 15 shows a process that compares the group of the servers compositely grouped by the composite processing module 130 with the servers 300 on the storage medium 16, 26 for connecting and storing the address information of at least one server 300 for each service or application at the pattern processing unit 15 or the signature processing unit 25 and sets the grouped servers 300 to the servers 300 connected with the services or applications connected to the addresses of the servers 300 matched on the storage medium 16, 26.

When the addresses of the servers 300 connected with the specific application (for example, Kakao Talk) already known on the storage medium 26 are the server A, the server B and the server C and the group of the servers 300 grouped by the pattern processing unit 25 are the server A, the server B, the server D, the server E and the server F, the server A and the server B of the group of the servers 300 are matched with the server A and the server B, connected with Kakao Talk, on the storage medium 26, and the servers 300 connected with Kakao Talk may be set to the group of the servers 300 including already known server A, server B and server C, and additive server D, the server E and the server F connected with Kakao Talk.

The storage medium 26 stores the address information of the servers 300 identified or known already for each specific service or application, the storage medium 26 for storing the predetermined inherent signatures (for example, gscdn.com, naver.com, apple.com, etc.) and the storage medium 26 for storing the address information of the servers 300 identified or known already for each specific service or application are shown as a single storage medium on the drawings, but the storage medium 26 for storing the predetermined inherent signatures (for example, gscdn.com, naver.com, apple.com, etc.) and the storage medium 26 for storing the address information of the servers 300 identified or known already for each specific service or application may be configured as a separate storage medium.

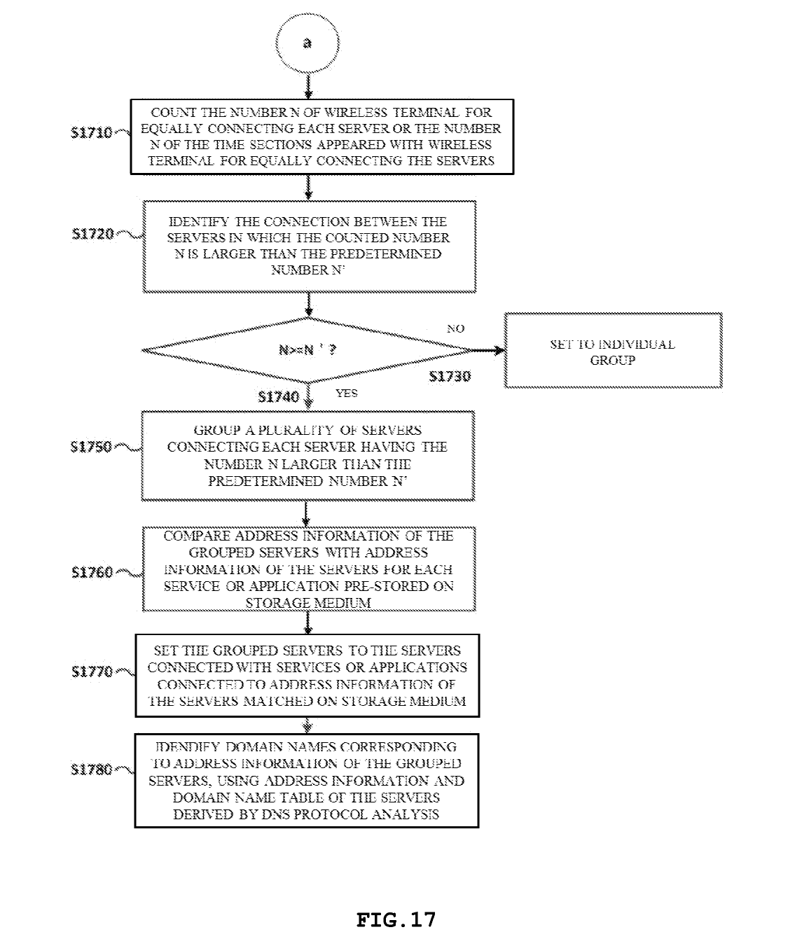

FIG. 16 shows a first process of server 300 pattern grouping according to an embodiment of the present invention.

Firstly, the device 100 for server grouping collects or captures a plurality of packets for mutually transceiving between a plurality of wireless terminals 200 and servers 300 at the communication network by the packet collection module 105 (S1610).

Further, the device 100 for server grouping connects the collected or captured packets and the packet collection or capture time information (or the packet switching information) to the subject and the object transceiving each packet, that is, the identification information (for example, IP information) of each wireless terminal 200 and the address information (for example, IP/PORT information) of each server 300 and maps the connected them (S1620).

At this time, the packet collection module 105 of the device 100 for server grouping determines filtering for common packets commonly transceiving to a plurality of services or applications on the collected or captured packet, and excludes the common packets when the common packets are present (S1630).

After Step S1630, when a common packet filtering process is omitted (S1640), the device 100 for server grouping aligns the address information of a plurality of servers 300 connected within the predetermined time for each wireless terminal 200 for the mapped packets by the alignment unit 13 for each packet collection or capture time (S1650).

The device 100 for server grouping connects a first server 300, a second server 300, a n-th (n=3, 4, . . . n) server 300 connected with the wireless terminals 200 within the predetermined time, using information aligned by the alignment unit 13, through the pattern extraction unit 14 for each packet collection or capture time (S1660).

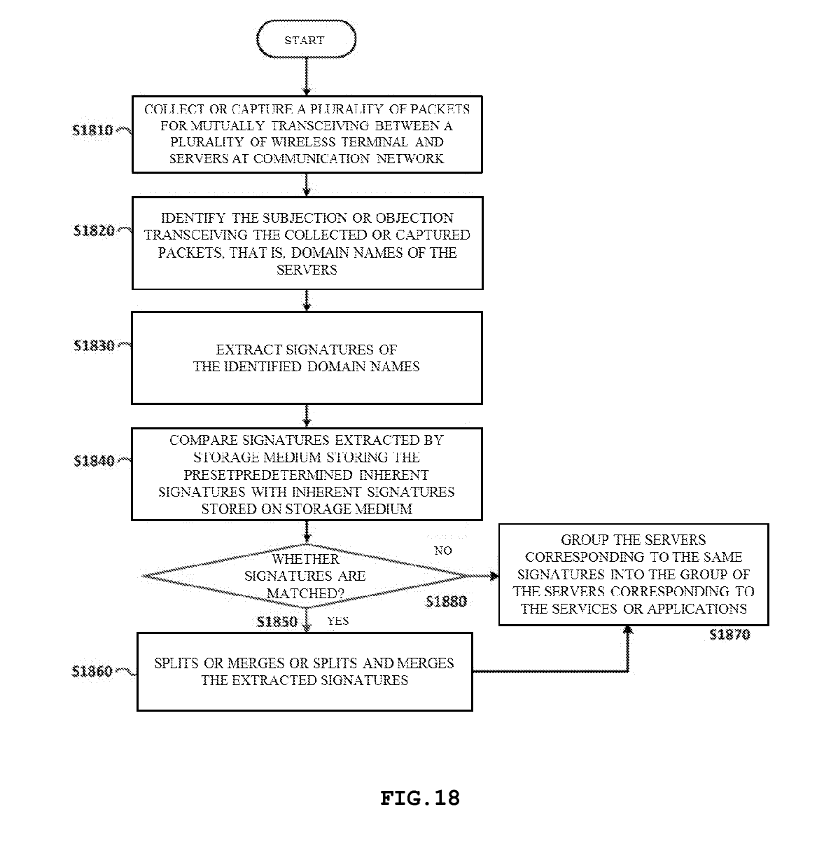

FIG. 17 shows a second process of server 300 pattern grouping according to an embodiment of the present invention.

The device 100 for server grouping counts the number N of the wireless terminal 200 for equally connecting each server 300 or the number N of the time sections appeared with the wireless terminal 200 for equally connecting the servers 300 by the pattern extraction unit 14 (S1710).

The device 100 for server grouping identifies the connection between the servers 300 in which the number of the wireless terminals 200 or the number N of the time sections appeared with the wireless terminal 200 for equally connecting the servers 300, counted at the Step S1710 by the pattern processing unit 15, is larger than the predetermined number N′ (S1720). The predetermined number N′ may be set as the relative values, corresponding to the number of the connection between different servers, no absolute values. The device 100 for server grouping identifies the number of the connection (server pairs) between different servers and determines values N′ as the relative values for the number on determining, for example, the values N′.

The group of the servers is not configured in the case that the number N of the wireless terminals 200 or the number N of the time sections appeared with the wireless terminals 200 equally connecting the servers 300, counted by Step S1720, is smaller than the predetermined number N′, and the device 100 for server grouping groups a plurality of servers 300 connecting each servers 300 having the number N of the wireless terminals 200 or the number N of the time sections appeared with the wireless terminals 200 for equally connecting the servers 300, counted by the pattern processing unit 15, larger than the predetermined number N′ into the group of the servers 300 corresponding to a single service or application (S1750) in the case that the number N of the wireless terminals 200 or the number N of the time sections appeared with the wireless terminals 200 equally connecting the servers 300, counted by Step S1720, is equal to or larger than the predetermined number N′ (S1740).

Then, the pattern processing unit 15 of the device 100 for server grouping compares the address information of the grouped servers 300 with the address information of the servers 300 stored on the storage medium 16 by the storage medium 16 connecting and storing the address information of at least one servers 300 for each service or application (S1760).

When the address information of the grouped servers 300 and the address information of the servers 300 stored on the storage medium 16 are matched at Step S1760, the grouped servers 300 are set to the servers 300 connected with the services or applications connected to addresses of the servers 300 matched on the storage medium 16 (S1770).

In addition, the pattern processing unit of the device 100 for server grouping identifies the domain names corresponding to the addresses of the grouped servers 300, using the address information and the domain name table of the servers 300 derived by DNS (Domain Name System) protocol analysis (S1780).

Step S1780 may be included in Step S1750 or any processes.

Further, Step S1760 to Step S1780 may be applied to the servers excluded from composite grouping performed by the composite processing module 130.

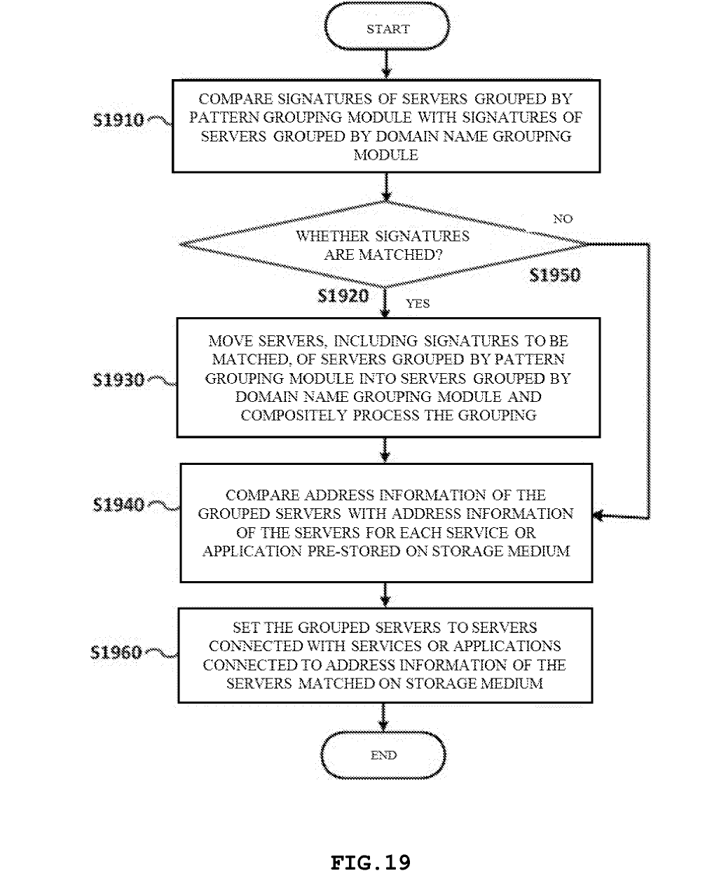

FIG. 18 shows server domain name grouping processes according to an embodiment of the present invention.

Firstly, the device 100 for server grouping collects or captures a plurality of packets for mutually transceiving between a plurality of wireless terminal 200 and servers at the communication network by the packet collection module 105 (S1810).

A identifying unit 22 identifies the subjection or objection transceiving packets collected or captured by the packet collection module 105, that is, the domain names of the servers 300 in the device 100 for server grouping (S1820).

The identifying unit 22 of the device 100 for server grouping identifies the domain names corresponding to the subject and the object transceiving the packets, that is, the addresses of the servers 300, using the address information and the domain name table of the servers 300 derived by DNS (Domain Name System) protocol analysis.

The device 100 for server grouping extracts the signatures of the domain names identified from the identifying unit 22 by the signature extraction unit 23 (S1830).

The device 100 for server grouping compares the signatures extracted by the signature extraction unit 23 with the inherent signatures pre-stored on the storage medium 26 storing the predetermined inherent signatures (for example, gscdn.com, naver.com, apple.com, etc.) by the COMPARISON UNIT 24 (S1840).

After comparing at Step S1840, when at least one of the inherent signatures pre-stored on the storage medium 26 is matched with the signatures extracted by the signature extraction unit 23 (S1850), the device 100 for server grouping splits or merges or splits and merges the signatures extracted by the signature extraction unit 23 by the signature processing unit 25 (S1860).

Then, the device 100 for server grouping groups the servers 300 corresponding to the same signatures of the signatures split or merged or split and merged by the signature processing unit 25 into the group of the servers 300 corresponding to the services or applications (S1870).

After comparing at Step S1840, when at least one of the inherent signatures pre-stored on the storage medium 26 is matched with the signatures extracted by the signature extraction unit 23 (S1850), the device 100 for server grouping splits or merges or splits and merges the signatures extracted by the signature extraction unit 23 by the signature processing unit 25 (S1860).

Although not separately shown in the drawing, after the servers excluded from the composite grouping performed by the composite processing module 130 compares with the servers 300 on the storage medium 26 connecting and storing each address information of the group of the servers 300 grouped by the signature processing unit 25 to the address information of at least one servers 300 for each service or application in the device 100 for server grouping, the grouped servers 300 is set to the servers 300 connected with the service or application connected to the address information of the servers 300 matched on the storage medium 26.

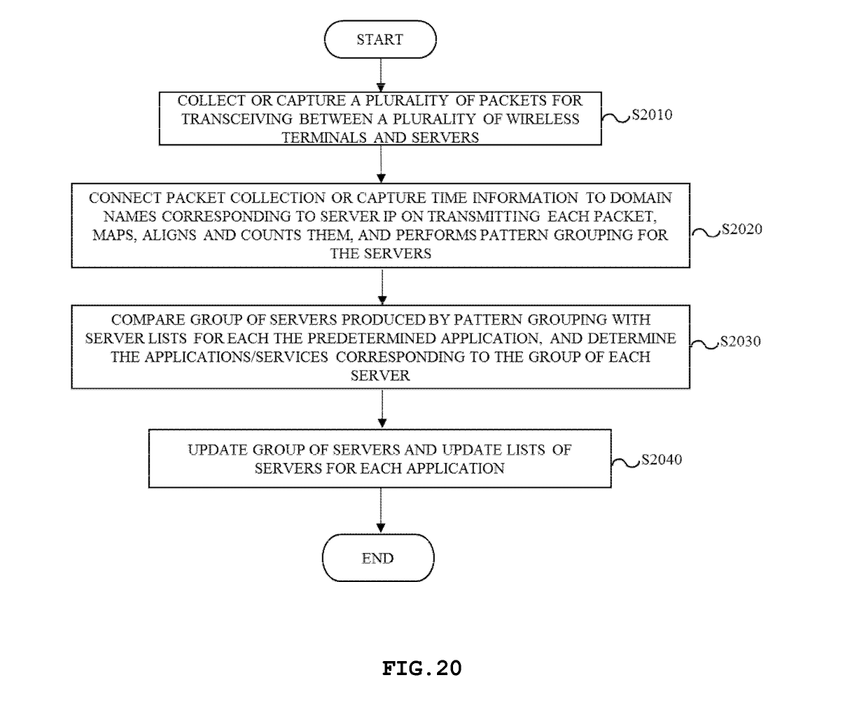

FIG. 19 shows composite grouping processes according to an embodiment of the present invention.

The device 100 for server grouping compares the signatures of the servers grouped by the pattern grouping module 110 with the signatures of the servers grouped by the domain name grouping module 120, by the composite processing module 130 (S1910).

After comparing at Step S1910, when the signatures, to be matched to the signatures of the servers grouped by the domain name grouping module 120, of the signatures of the servers grouped by the pattern grouping module 110 are present (S1920), the composite processing module 130 moves the servers, including the signatures to be matched, of the servers grouped by the pattern grouping module 110 into the servers grouped by the domain name grouping module 120 and compositely processes the grouping (S1930).

The device 100 for server grouping compares the addresses between the servers 300 on the storage medium 16, 26 connecting and storing the address information of at least one servers 300 for each specific service or application and the group of the servers processing the composite grouping in the composite processing module 130 by the pattern processing unit 15 or the signature processing unit 25 (S1940).

After comparing at Step S1910, when the signatures, to be matched to the signatures of the servers grouped by the domain name grouping module 120, of the signatures of the servers grouped by the pattern grouping module 110 are absent (S1950), Step S1930 is omitted and it moves into Step S1940.

Then, the device 100 for server grouping sets compositely grouped servers 300 to the servers 300 connected with the services or applications connected to the addresses of the servers 300 matched on the storage medium 16, 26, in response to the result of the comparison at Step S1940, by the pattern processing unit 15 or the signature processing unit 25 (S1960).

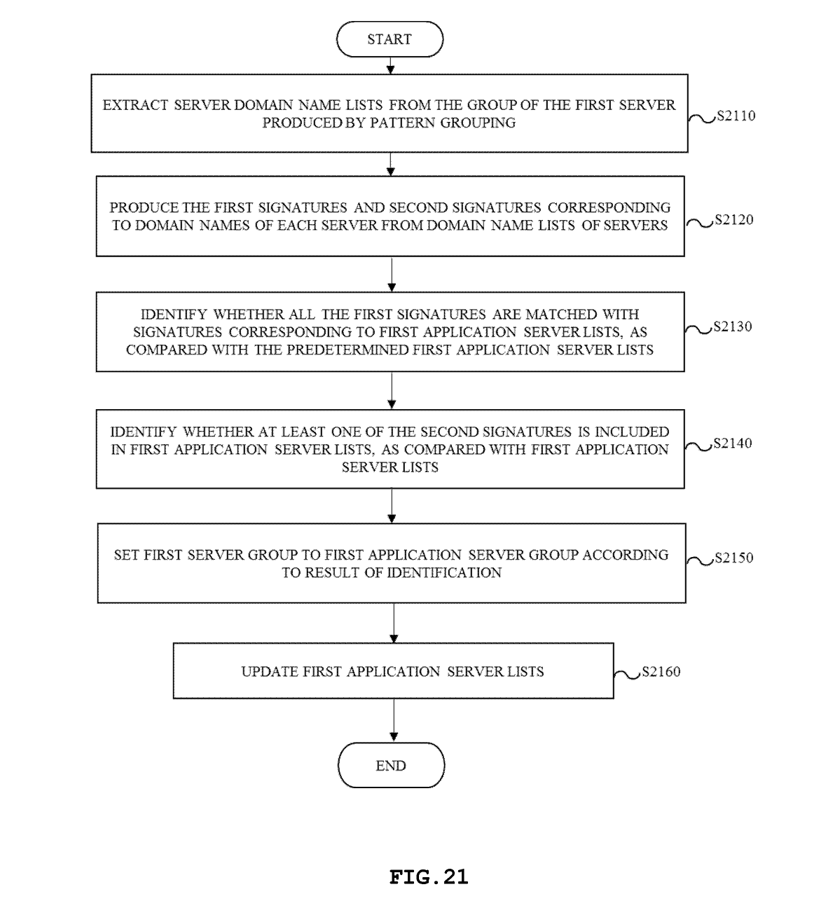

FIG. 20 shows a flow chart for describing the device 100 for server grouping according to another embodiment of the present invention.

On the other hand, according to another embodiment of the present invention, the device 100 for server grouping performs the grouping considering the time adjacency between the packets and uses the domain name information as information for identifying the servers 300 to be grouped, on grouping the servers 300. As described above, identification information of the server 300 is used as the address information, and the address information, for example, includes at least one of IP information, port information and domain name information.

Firstly, the device 100 for server grouping collects or captures a plurality of packets for mutually transceiving between a plurality of wireless terminals 200 and servers 300 at the communication network by the packet collection module 105 (S2010).

The device 100 for server grouping connects the packet collection or capture time information to the domain names corresponding to the server IP on transmitting each packet, maps, aligns and counts them, and performs the pattern grouping for the servers (S2020).

The device 100 for server grouping aligns the packets and counts appearing time sections by the packet collection module 105, the alignment unit 13 and the pattern extraction unit 14 as described above, and produces at least one group of the servers by performing the pattern grouping for the servers according to the time sections counted by the pattern processing unit 15.

When the domain name information is used as the address information of each server 300, the domain names may become the domain names corresponding to the server IP on transmitting each packet. Further, the packet collection module 105 connects the domain name information to the packet collection or capture time information and maps the connected them.

For example, when one wireless terminal 200 communicates with the application server 300, patterns of the transceived packet(s) may be found within predetermined time in communication processes on analyzing packet flow. In this case, the device 100 for server grouping may group the servers 300 into at least one group according to the domain name information of the servers 300 transceiving the packets, connected with the wireless terminals 200, during predetermined time based on time interval between each packet. Therefore, the groups of each server may include at least one server domain names. The domain name information may be used as the identification information for the servers 300 transmitting the packets, and may be acquired from request information for a DNS server on identifying the IP to transmit the packets.

In addition, the device 100 for server grouping compares the group of the servers produced by the pattern grouping with the server lists for each the predetermined application, and determines the applications/services corresponding to the group of each server (S2030).

As shown in FIG. 15 above, the group of the servers determined by the pattern processing unit 15 is predetermined and may be compared with the server lists for each specific application stored on the storage medium 16, 26. The device 100 for server grouping identifies the applications to be matched on the storage medium 16, 26, determines the applications/services, and assigns them, for the group of each server.

In particular, comparison conditions use the domain names in the present embodiment. For example, the lists of the servers 300 corresponding to the specific application (for example, Kakao Talk) predetermined on the storage medium 26 may be included with the domain name corresponding to the server A, the domain name corresponding to the server B and the domain name corresponding to the server C. In addition, when the domain names to be matched with the servers are included in the specific server group, the device 100 for server grouping may allocate the applications for the group of the servers into the specific applications.

According to the embodiment of the present invention, the server lists for each application may be extracted from the wireless terminal 200. The wireless terminals 200 produce connection server information for each application based on at least one of IP, domain names or PORT of the servers connected on executing the specific application and transmits it to the device 100 for server grouping. The device 100 for server grouping may store the lists of the servers for each application according to the connection server information for each application received from the wireless terminals 200 into the storage medium 16, 26. The lists of the servers for each application, for example, may include application type information, application identification information and server list information. The application type information may include at least one of the applications, address input web services, automatic address producing web services and cloud services. Further, the application identification information may be identified and extracted from application files installed into the wireless terminals 200. Further, the list information of the servers may include at least one of the domain names, IP information or port information in each server.

Therefore, the device 100 for server grouping updates the group of the servers according to the result of the application/service allocation, and updates the lists of the servers for each application (S2040).

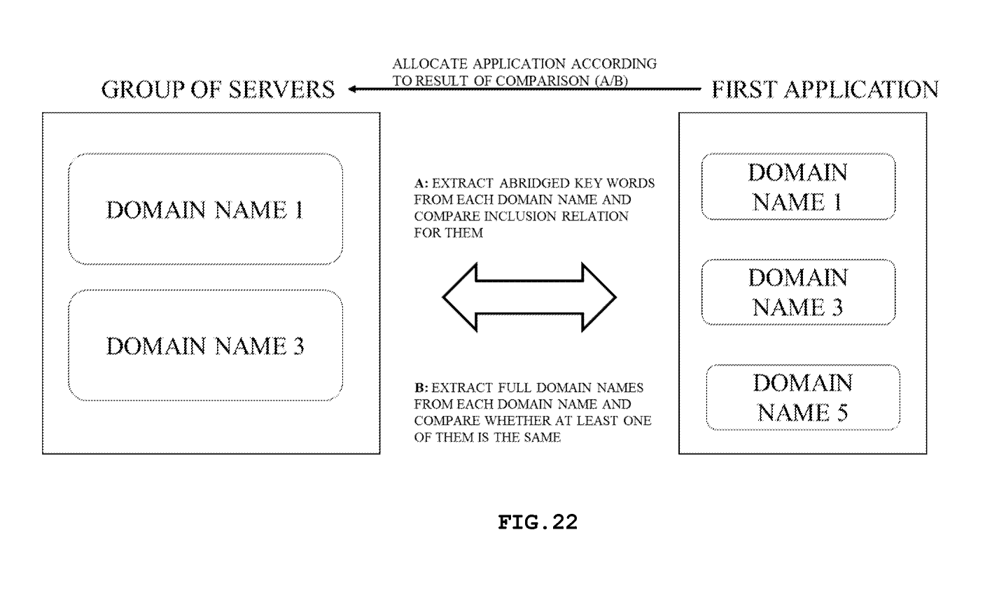

FIG. 21 and FIG. 22 describe the processes for matching the lists of the servers with the group of the servers for each application according to the embodiment of the present invention.

Referring to FIG. 21 and FIG. 22, in order to perform the matching between the lists of the servers and the group of the servers for each application, the device 100 for server grouping extracts, compares and matches at least one of a first signature and a second signature from the domain names and therefore may more accurately allocate the applications/services corresponding to the group of the grouped servers. Matching processes to be described later are autonomously performed in the pattern grouping module 110 of the device 100 for server grouping, or may be performed by the composite processing module 130.

The device 100 for server grouping extracts the server domain name lists from the group of the first server produced by the pattern grouping (S2110).

As described in FIG. 20 above, the identification information of the servers 300 grouped from the pattern grouping may be included with the domain names. Therefore, when the group of the first server is grouped, the device 100 for server grouping may extract the domain names corresponding to each server 300 included in the group of the first servers as domain name lists of the servers.

Further, the device 100 for server grouping produces the first and second signatures corresponding to the domain names of each server from the domain name lists of the servers (S2120), identifies whether all the first signatures are matched with the signatures corresponding to the first application server lists, as compared with the predetermined first application server lists (S2130), and identifies whether at least one of the second signatures is included in the first application server lists, as compared with the predetermined first application server lists (S2140). At least one of the Step S2130 and S2140 may be applied to allocate the applications/services and the order thereof may be changed according to accuracy.

In more derail, the device 100 for server grouping may extract the first and second signatures from the domain name lists.

The first signatures may include abridged key words extracted from the domain names. Abridged parameters for extracting the abridged key words may be changed according to user setting applied to the device 100 for server grouping. For example, the abridged parameters may be set by stages from the lowest label of the domain names. For example, when the parameters are set by steps of two, the first server group is included with “music.naver.com” as the domain name of the first server, is included with “cafe.naver.com” as the domain name of the second server, and is included with “facebook.com” as the domain name of the third server, the first signatures are abridged and extracted as “naver.com” and “facebook.com” and the duplicated signatures are integrated into one.

On the other hand, the second signatures may include full domain name key words extracted from the domain names. The full domain name keywords may be “music.naver.com”, “cafe.naver.com” and “facebook.com” in case of the first server group as above and therefore the second signatures may be extracted.

As shown in FIG. 22, the extracted first and second signatures may be compared with the domain names corresponding to each first application. The device 100 for server grouping may extract the first signatures according to the same abridged parameters from the first application server lists for the comparison, and may extract the second signatures according to the full domain name key words.

The device 100 for server grouping identifies whether the first signatures extracted from the first server group are matched with the first signatures extracted from the first application server lists and therefore identifies whether the first application may be allocated into the first server group. Since the accuracy may be low by the comparison of the first signatures only, the device 100 for server grouping identifies whether at least one of the second signatures extracted from the first server group are included in the second signatures of the first application server lists and therefore identifies whether the first application may be allocated into the first server group.

The device 100 for server grouping compositely performs the matching between the connection server lists and the domain names included in the server group for each pre-extracted application, and may identify whether the applications corresponding to the server group with high probability are which applications/services.

According to the result of the identification, the device 100 for server grouping sets the first server group to the server group corresponding to the first application (S2150), and updates the first application server lists (S2160).

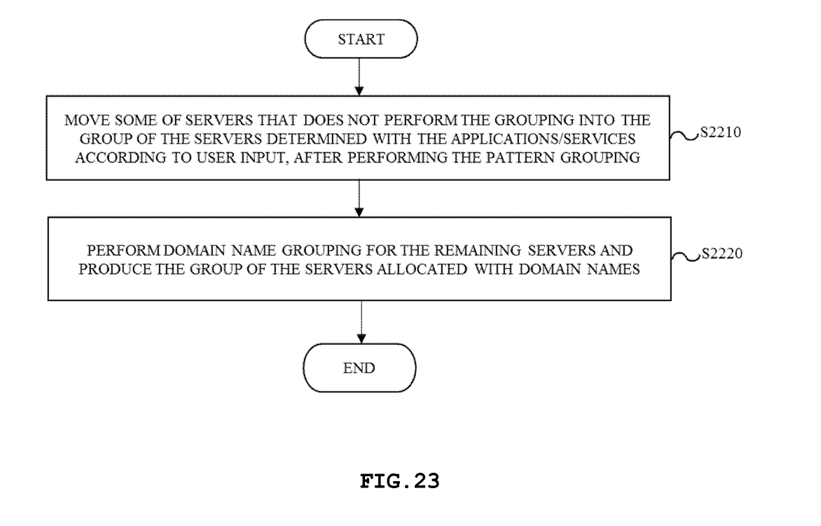

FIG. 23 shows a flow chart for describing domain name grouping processes according to another embodiment of the present invention.

According to the embodiment of the present invention, the device 100 for server grouping firstly performs the pattern grouping and produces the server groups, performs the correction according to user input for the remaining mapping result that does not perform the grouping, and secondly performs the domain name grouping. This may be performed by the composite grouping module 130.

To this end, after performing the pattern grouping, the device 100 for server grouping moves some of the servers that does not perform the grouping into the group of the servers determined with the applications/services according to user input (S2210). For example, some of the address information of the servers that were not included in the server group produced by the pattern grouping may be moved into the group of the servers according to the user input.

Hereinafter, the device 100 for server grouping performs the domain name grouping for the remaining servers and produces the group of the servers allocated with the domain names (S2220).

Therefore, the above-described domain name grouping module 120 does not cover the server grouping performed by the pattern grouping module 110, performs the domain name grouping for different servers not determined with the applications/services, and produces and manages the server groups corresponding to the domain names.

According to an embodiment of the present invention, the servers performing packet switching for each specific or application are grouped, thereby to detect the specific services or applications causing overload at the communication network and therefore to block or control unnecessary execution causing network loads for each specific service or application.

Further, this may optimally use the networks at a wireless terminal stage, and it is possible to minimize network expansion cost of mobile communication companies by optimization of network use.

According to further another embodiment of the present invention, on optimizing network use, it is possible to minimize dissatisfaction for the wireless terminal's user caused by data communication delay, etc. and to greatly reduce battery consumption for the wireless terminal.

The method according to above-described present invention is manufactured with program performing in a computer and is stored to the computer-readable recording medium. Examples of the computer-readable recording medium are a ROM, a RAM, a CD-ROM, a magnetic tape, a floppy disk, an optical data storage device and the like, and may be also implemented in a type of carrier waves (for example, transmittance through Internet).

The computer-readable recording medium is distributed to the computer system connected to network, and the computer-readable code is stored in a distributed way and may be performed. Further, functional program, code, code segments implementing the method may be easily inferenced by programmer in the art to which the present invention belongs.

In addition, although the preferred embodiments of the present invention are shown and described above, the present invention is not limited to above-described specific embodiment and is variously modified by one skilled in the art without the gist of the present invention claimed in the claim, such that the modified embodiment is not to be understood separately from technical ideas or views of the present invention.

What is claimed is:

1. A device for server grouping, comprising: a packet collection module for collecting or capturing communication packets for transceiving between at least one wireless terminals and servers, for mapping packet collection or capture time information with server address information, wherein the server address information including domain names of the servers; and
a pattern grouping module for identifying address information of the servers within predetermined time for each wireless terminal for the mapped packets according to the packet collection or capture time information, connecting the servers for each wireless terminal within the predetermined time, counting the number of the presences of wireless terminals corresponding to the connection between the servers, and grouping at least one servers having the number of the counted wireless terminal larger than a predetermined number into the group of the servers corresponding to a specific applications.

2. The device for server grouping according to claim 1, further comprising a domain name grouping module for identifying the subjection or objection for transceiving the collected or captured packets, that is, the domain names of the servers, extracting the signatures of the identified domain names, comparing the extracted signatures with inherent signatures pre-stored in a storage medium by the storage medium storing the predetermined inherent signatures, splitting or merging or splitting and merging the extracted signatures in response to the result of the comparison, and grouping the servers corresponding to the same signatures of the split or merged or split and merged signatures into the group of the servers corresponding to the specific domain names.

3. The device for server grouping according to claim 2, wherein, after performing grouping by the pattern grouping module, the domain name grouping module performs grouping by the domain names for the servers that do not be grouped by the pattern grouping module and produces a group of the servers corresponding to specific domain names.

4. The device for server grouping according to claim 1, wherein the pattern grouping module compares the server group produced by the pattern grouping with the server lists for each the predetermined application and determines the specific applications corresponding to the group of the servers on grouping into the group of the servers corresponding to the specific applications.

5. The device for server grouping according to claim 1, wherein the pattern grouping module extracts domain name lists from a first server group, produces at least one of first or second signatures from the domain name lists, compares the first or second signatures with a first application server lists and groups the first server group into the group of the servers corresponding to the first application on grouping into the group of the servers corresponding to the specific applications.

6. The device for server grouping according to claim 5, wherein the first signatures include abridged key words converted from the domain name lists, and the pattern grouping module groups the first server group into the group of the servers corresponding to the first application in the case that all the abridged key words are matched with the first application server lists.

7. The device for server grouping according to claim 5, wherein the second signatures include full domain name keywords extracted from the domain name lists, and the pattern grouping module groups the first server group into the group of the servers corresponding to the first application in the case that at least one of the full domain name key words is matched with the first application server lists.

8. The device for server grouping according to claim 1, wherein the packet collection module filters and excludes the packets, commonly transceived to a plurality of services or applications, of the collected or captured packets.

9. The device for server grouping according to claim 1, wherein the pattern grouping module includes
a alignment unit for aligning the address information of the servers connected within the predetermined minimum time for each wireless terminal to the mapped packets for each packet collection or capture time;
an extraction unit connecting a first server, a second server, n-th (n=3, 4, . . . n) server connected with the wireless terminal, within the predetermined minimum time for each packet collection or capture time, using information aligned by the alignment unit, and counting the number N of the wireless terminal equally connecting the servers; and
a processing unit for grouping a plurality of servers for connecting the servers having the number N of the wireless terminal, counted by the extraction unit, larger than the predetermined number N′ into the group of the servers corresponding to a single service or application.

10. The device for server grouping according to claim 1, wherein the pattern grouping module connects by the pairs and counts the servers appeared within the predetermined time from the collected or captured packets, calculates the number of the relationships between the servers by the counting of the pairs, and groups the servers into at least one or more groups based on a relative or statistical relationship values, wherein the relative relationship values are calculated by using the absolute number of the servers appeared from the packets and the number of the relationships between the servers, and wherein the statistical relationship values are calculated by using the absolute number of the server pairs appeared from the packets and the number of the relationships between the servers.

11. A method for server grouping, comprising: collecting or capturing communication packets for transceiving between at least one wireless terminals and servers, and mapping packet collection or capture time information with server address information including domain names of the servers being transmitted with the packets; and
identifying address information of the servers connected within predetermined time for each wireless terminal for the mapped packets according to the packet collection or capture time information, connecting the servers connected for each wireless terminal within the predetermined time, counting the number of the wireless terminals corresponding to the connection between the servers, and grouping at least one servers connecting the servers having the number of the counted wireless terminals larger than the predetermined number into the group of the servers corresponding to the specific application.

12. The method for server grouping according to claim 1, further comprising identifying the subjection or objection for transceiving the collected or captured packets, that is, the domain names of the servers, extracting the signatures of the identified domain names, comparing the extracted signatures with inherent signatures pre-stored in a storage medium by the storage medium storing the predetermined inherent signatures, splitting or merging or splitting and merging the extracted signatures in response to the result of the comparison, and grouping the servers corresponding to the same signatures of the split or merged or split and merged signatures into the group of the servers corresponding to the specific domain names.

13. A method for server grouping, comprising: extracting domain name lists from a first server group, producing at least one of first or second signatures from the domain name lists, and comparing the first or second signatures with a first application server list and grouping the first server group into the group of the servers corresponding to the first application server lists, wherein the first signatures include abridged key words converted from the domain name lists and the second signatures include full domain name key words extracted from the domain name lists, and grouping the first server group into the group of the servers corresponding to the first application when all the abridged key words are matched with the first application server lists or at least one of the full domain name key words are included in the first application server lists.

14. A non-transitory recording medium for recording programs for causing a computer to execute a method described in claim 11.

15. A non-transitory recording medium for recording programs for causing a computer to execute a method described in claim 12.

16. A non-transitory recording medium for recording programs for causing a computer to execute a method described in claim 13.
